(19) United States
(12) Patent Application Publication
(10) Pub. No.: US 2016/0146227 A1
(43) Pub. Date: May 26, 2016

(54) Pilot Circuit for Working Vehicle

(71) Applicant: CATERPILLAR SARL, Geneva (CH)

(72) Inventor: Shota Hoshaku, Tokyo (JP)

(73) Assignee: CATERPILLAR SARL, Geneva (CH)

(21) Appl. No.: 14/903,250

(22) PCT Filed: Jul. 10, 2014
(86) PCT No.: PCT/EP2014/064843

§ 371 Date: Jan. 6, 2016

(30) Foreign Application Priority Data
Jul. 12, 2013 (JP) 2013-146074

(51) Int. Cl. F15B 13/044; F15B 15/14

(52) U.S. Cl. CPC F15B 13/044; F15B 15/149

(57) ABSTRACT

The machine includes an operation selection switch to choose either an oil-pressured pilot operation or an electric operation, a control device to input an electric signal for traveling transmitted from an electric operation device and a selection signal from the operation selection switch. A third electro-magnetic valve may forbid outputting pilot pressure from a pilot valve, a first to fourth electro-magnetic proportional valve outputting a pilot pressure to the control valve for traveling based on the control signal from the control device and a first to fourth shuttle valve leading the output pilot pressure to the control valve for traveling.

### TECHNICAL FIELD

The present invention relates to working vehicles such as a hydraulic excavator.

### BACKGROUND ART

In general, working vehicles may be configured to include a traveling apparatus driven using a hydraulic actuator. A hydraulic excavator is a representative example of such a working vehicle, and includes left and right crawlers as the traveling apparatus, a hydraulic motor that drives the left and right crawlers and a control valve that performs oil supply and discharge control for the hydraulic motor. Further, the hydraulic excavator includes, as operation tools for traveling, left and right operation levers erected from a floor section in front of an operator's seat and left and right pedals attached to the left and right operation levers. Furthermore, joystick-type operation levers are provided on the left and right sides of the operator's seat, as operation tools for work such as turning an upper turning body and actuating a boom, a stick and a bucket.

A hydro-mechanical pilot valve actuated by operation of an operation tool for traveling to output the pilot pressure has been widely used for supplying a pilot pressure to the control valve for traveling.

On the other hand, Japanese Patent Applications Laid-Open No. 2000-27238, 2004-100397, 2005-273443, 2007-162279 all disclose a hydraulic excavator configured to electrically detect operation of an operation tool for traveling, input the operation to a controller, and actuate an electromagnetic control valve for traveling (or an electromagnetic pilot valve that outputs a pilot pressure to a control valve for traveling of a hydraulic pilot type) on the basis of a control signal output from the controller. Further, such prior art also describe a technique for making it possible to use the left and right joystick-type operation lever provided as an operation tool for work also as an operation tool for traveling.

Incidentally, the hydraulic excavator described in the prior art is configured to be capable of performing only one of hydraulic pilot operation for actuating the pilot valve with the operation tool for traveling or electrohydraulic operation for actuating an electromagnetic valve for traveling (an electromagnetic control valve for traveling or an electromagnetic pilot valve for traveling). As the electric operation tool, the left and right operation levers for traveling, the left and right pedals for traveling, or the left and right joystick-type operation levers conventionally included in the hydraulic excavator are used.

However, nowadays, demands concerning operability are diversified according to types and work contents of various attachments attached to working vehicles, skills and preferences of operators, or the like. In particular, when a working vehicle is used in a rental business, various kinds of work are performed by a large number of operators. Therefore, if only any one of hydraulic pilot operation or electrohydraulic operation can be performed, in some cases, demands of the operators cannot be met. Further, there is also a demand that not only the operation tools conventionally in use but also an operation tool such as a switch, which can be easily operated, is used as the operation tool for traveling.

In view of the circumstances explained above, the present invention has been devised to solve these problems.

### SUMMARY OF THE INVENTION

According to the present invention, a working vehicle includes a hydraulic motor that drives a traveling apparatus, a control valve for traveling of a hydraulic pilot type that performs oil supply and discharge control for the hydraulic motor, an operation tool that mechanically actuates a hydraulic pilot valve that in turn outputs a pilot pressure to the control valve for traveling, and an electric operation device that outputs an electric signal for traveling. The working vehicle further includes operation selecting means for selecting the hydraulic pilot operation or the electric operation, a control apparatus that receives the electric signal and selection signal from the operation selecting means to produce a control signal supplied to an electromagnetic valve for prohibiting an output of the pilot pressure from reaching the control valve for traveling. An electromagnetic proportional valve for electric operation outputs pilot pressure to the control valve for traveling on the basis of the control signal from the control apparatus, and a shuttle valve guides the pilot pressure output from one of the hydraulic pilot valve or the electromagnetic proportional valve to the control valve for travelling.

An invention of claim 2 is characterized in that, in claim 1, the working vehicle includes: a hydraulic actuator for work; a control valve for work of a hydraulic pilot type that performs oil supply and discharge control for the hydraulic actuator for work; a pilot valve for work that outputs the pilot pressure to the control valve for work; and a joystick-type operation lever, the joystick-type operation lever has a function of a hydraulic pilot operation tool for work that actuates the pilot valve for work on the basis of lever operation, and a function of the electric operation device for traveling that outputs the electric signal for traveling to the control apparatus on the basis of lever operation, and, the working vehicle is provided with an electromagnetic valve for prohibiting pilot operation for work that prohibits an output of the pilot pressure from the pilot valve for work to the control valve for work on the basis of the control signal from the control apparatus.

An invention of claim 3 is characterized in that, in claim 1 or 2, in the working vehicle, the operation selecting means is provided in the electric operation device for traveling.

An invention of claim 4 is characterized in that, in claim 1 or 2, in the working vehicle, the electric operation device for traveling is also used as the operation selecting means by using, as the selection signal, the electric signal for traveling output from the electric operation device for traveling.

According to the invention, it is arbitrarily select any one of hydraulic pilot operation and electric (electrohydraulic) operation according to types and work contents of various attachment attached to the working vehicle, skills and preferences of operators, or the like. It is possible to meet diversified demands for operability. Moreover, even if various operation tools and electric devices are used, it is possible to select the hydraulic pilot operation and the electric operation with entirely the same configuration. Therefore, it is possible to perform traveling operation using the various operation tools to attain further diversification of the traveling operation.

According to the invention of claim 2, it is possible to directly use, as the electric operation device for traveling, the joystick-type operation lever used as the hydraulic pilot operation tool for work. It is possible to select the hydraulic pilot operation and the electric operation without separately providing the electric operation device for traveling.

According to the invention of claim 3, the working vehicle is excellent in operability.

According to the invention of claim 4, there is an advantage that it is unnecessary to separately provide operation selecting means and it is unnecessary to separately operate the operation selecting means.

### BRIEF DESCRIPTION OF THE DRAWINGS

FIG. 1 is a side view of a hydraulic excavator.

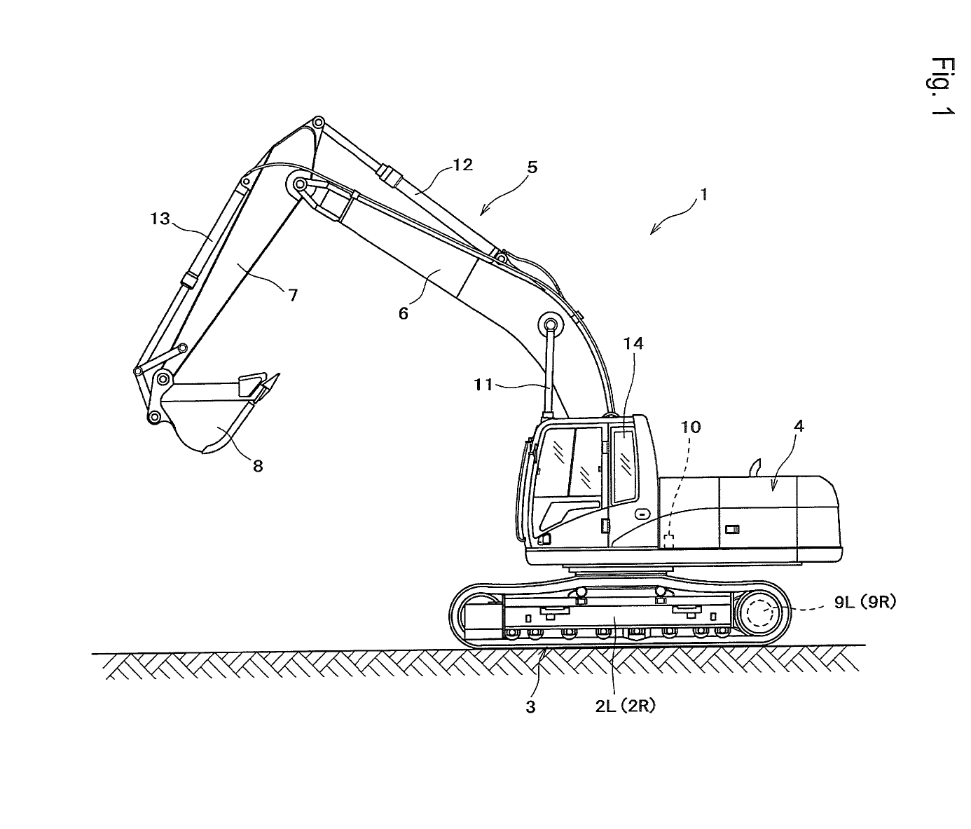

FIG. 2 is a perspective view showing the inside of an operator's cab.

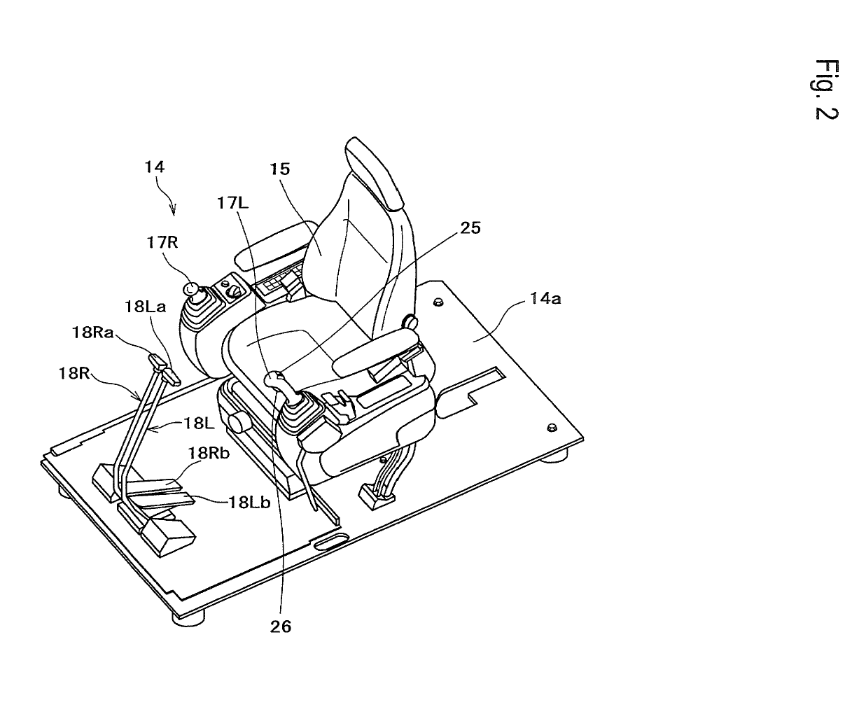

FIG. 3 is a hydraulic circuit diagram of the hydraulic excavator.

FIG. 4 is a hydraulic circuit diagram of the hydraulic excavator.

FIG. 5 is a perspective view showing a disposing state of first to third electromagnetic valves.

FIG. 6 is a perspective view showing a disposing state of first to fourth electromagnetic proportional valves.

FIG. 7 is a block diagram showing an input and an output of a control apparatus in a first embodiment.

FIG. 8 is a flowchart showing a control procedure of the control apparatus.

FIG. 9 is a flowchart showing a control procedure of electric operation control.

FIG. 10 is a diagram showing a relation between operation of an electric operation device and a traveling direction of a hydraulic excavator in the first embodiment.

FIG. 11 is a block diagram showing an input and an output of a control apparatus in a second embodiment.

FIG. 12 is a diagram showing a relation between operation of an electric operation device and a traveling direction of a hydraulic excavator in the second embodiment.

FIG. 13 is a block diagram showing an input and an output of a control apparatus in a third embodiment.

FIG. 14 is a diagram showing a relation between operation of an electric operation device and a traveling direction of a hydraulic excavator in the third embodiment.

FIG. 15 is a block diagram showing an input and an output of a control apparatus in a fourth embodiment.

FIG. 16 is a diagram showing a relation between operation of an electric operation device and a traveling direction of a hydraulic excavator in the fourth embodiment.

### BEST MODE FOR CARRYING OUT THE INVENTION

A first embodiment of the present invention is explained below with reference to the drawings. In the figures, reference numeral 1 denotes a hydraulic excavator, which is an example of a working vehicle. The hydraulic excavator 1 is configured from units such as a lower traveling body 3 including left and right traveling apparatuses 2L and 2R of a crawler type, an upper turning body 4 rotatably supported to swing horizontally above the lower traveling body 3, and a front working unit 5 attached to the upper turning body 4. The front working unit 5 includes a boom 6, a stick 7, and a bucket 8. The hydraulic excavator 1 includes various hydraulic actuators such as left and right traveling motors 9L and 9R for respectively driving the left and right traveling apparatuses 2L and 2R, a swing motor 10 for turning the upper turning body 4, and a boom cylinder 11, a stick cylinder 12, and a bucket cylinder 13 for respectively vertically rotating the boom 6, the stick 7, and the bucket 8. In the following explanation, the left and right traveling motors 9L and 9R, the swing motor 10, the boom cylinder 11, the stick cylinder 12, and the bucket cylinder 13 are also referred to as hydraulic actuators. In this embodiment, the left and right traveling motors 9L and 9R are equivalent to a hydraulic motor for traveling of the present invention. The swing motor 10, the boom cylinder 11, the stick cylinder 12, and the bucket cylinder 13 are equivalent to a hydraulic actuator for work of the present invention. Further, in this embodiment, the bucket 8 is disclosed as an attachment for work. However, various attachments such as a breaker, a magnet, and a ripper can alternatively be attached instead of the bucket 8.

Reference numeral 14 denotes an operator's cab provided in the upper turning body 4. In the operator's cab 14, an operator's seat 15 on which an operator sits is disposed. Left and right joystick-type operation levers (hereinafter referred to as joystick levers) 17L and 17R are disposed on the left and right sides of the operator's seat 15. Left and right operation tools for traveling 18L and 18R include left and right travel levers 18La and 18Ra and left and right travel pedals 18Lb and 18Rb disposed in front of the operator's seat 15.

The left and right joystick levers 17L and 17R has a function of a hydraulic pilot operation tool for work that actuates pilot valves 19A and 19B to 22A and 22B for a boom, a bucket, a stick, and swing on the basis of lever operation. That is, on the lower side of the left and right joystick levers 17L and 17R, the pilot valves 19A and 19B to 22A and 22B for the boom, the bucket, the stick, and swing are disposed. The pilot valves 19A and 19B to 22A and 22B can be actuated by tilting operation of the left and right joystick levers 17L and 17R. However, in this embodiment, when the left and right joystick levers 17L and 17R are caused to function as hydraulic pilot operation tools for work, the left joystick lever 17L is set for operation of the boom cylinder 11 and the bucket cylinder 13. The right joystick lever 17R is set for operation of the stick cylinder 12 and swing motor 10. The pilot valves 19A and 19B for the boom and the pilot valves 20A and 20B for the bucket are actuated by front, back, left, and right tilting operation of the left joystick lever 17L. The pilot valves 21A and 21B for the stick and the pilot valves 22A and 22B for swing are actuated by front, back, left, and right tilting operation of the right joystick lever 17R. The pilot valves 19A and 19B for the boom and the pilot valves 20A and 20B for the bucket are disposed on the lower side of the left joystick lever 17L in a state in which the pilot valves are integrally assembled and unitized. The pilot valves 21A and 21B for the stick and the pilot valves 22A and 22B for swing are disposed on the lower side of the right joystick lever 17R in a state in which the pilot valves are integrally assembled and unitized. The pilot valves 19A and 19B to 22A and 22B for the boom, the bucket, the stick, and swing are equivalent to a pilot valve for work of the present invention.

Further, left joystick lever 17L also has a function of an electric operation device for traveling that outputs an electric signal for traveling to a control apparatus 23 explained below on the basis of lever operation in addition to the function of the hydraulic pilot operation tool for work described above. That is, in the left joystick lever 17L, a potentiometer 24 that electrically detects an operation direction and an operation amount of the left joystick lever 17L is annexed. The operation direction and the operation amount of the left joystick lever 17L detected by the potentiometer 24 are input to the control apparatus 23 as an electric signal for traveling.

On the upper surface of a gripping section of the left joystick lever 17L, a maximum speed setting wheel 25 for setting maximum traveling speed of the left and right traveling apparatuses 2L and 2R is disposed. A value set by the maximum speed setting wheel 25 is input to the control apparatus 23 as one of electric signals for traveling. In this embodiment, the maximum speed setting wheel 25 can set the maximum traveling speed of the left and right traveling apparatuses 2L and 2R between 85% to 100%.

Further, an operation selection switch 26 is disposed on the rear surface of the gripping section of the left joystick lever 17L, to be turned on when the left joystick lever 17L is to function as the electric operation device for traveling described above. The operation selection switch 26 configures operation selecting means for selecting the hydraulic pilot operation or the electric operation of the present invention. Tilting operation of the left joystick lever 17L and pushing operation (ON operation) of the operation selection switch 26 can be simultaneously performed by one hand. A signal output according to the operation of the operation selection switch 26 is input to the control apparatus 23 as a selection signal. In this embodiment, the operation selection switch 26 is set to output an ON signal only while the operation selection switch 26 is pushed.

On the other hand, the left and right operation tools for traveling 18L and 18R (the left and right travel operation lever 18La and 18Ra and the left and right travel pedals 18Lb and 18Rb) function as hydraulic pilot operation tools for traveling that actuate left and right pilot valves for forward and backward traveling 27LA, 27LB, 27RA, and 27RB on the basis of operation tool operation. That is, the left and right pilot valves for forward and backward traveling 27LA, 27LB, 27RA, and 27RB are disposed on the lower side of the left and right travel pedals for traveling 18Lb and 18Rb. When the left operation tool for traveling 18L is operated to the forward traveling side, the left pilot valve for forward traveling 27LA is actuated. When the left operation tool for traveling 18L is operated to the backward traveling side, the left pilot valve for backward traveling 27LB is actuated. When the right operation tool for traveling 18R is operated to the forward traveling side, the right pilot valve for forward traveling 27RA is actuated. When the right operation tool for traveling 18R is operated to the backward traveling side, the right pilot valve for backward traveling 27RB is actuated. The left and right pilot valves for forward and backward traveling 27LA, 27LB, 27RA, and 27RB are disposed on the lower side of the left and right travel pedals 18Lb and 18Rb in a state in which the pilot valves are integrally assembled and unitized. The left and right pilot valves for forward and backward traveling 27LA, 27LB, 27RA, and 27RB are equivalent to a pilot valve for traveling of the present invention.

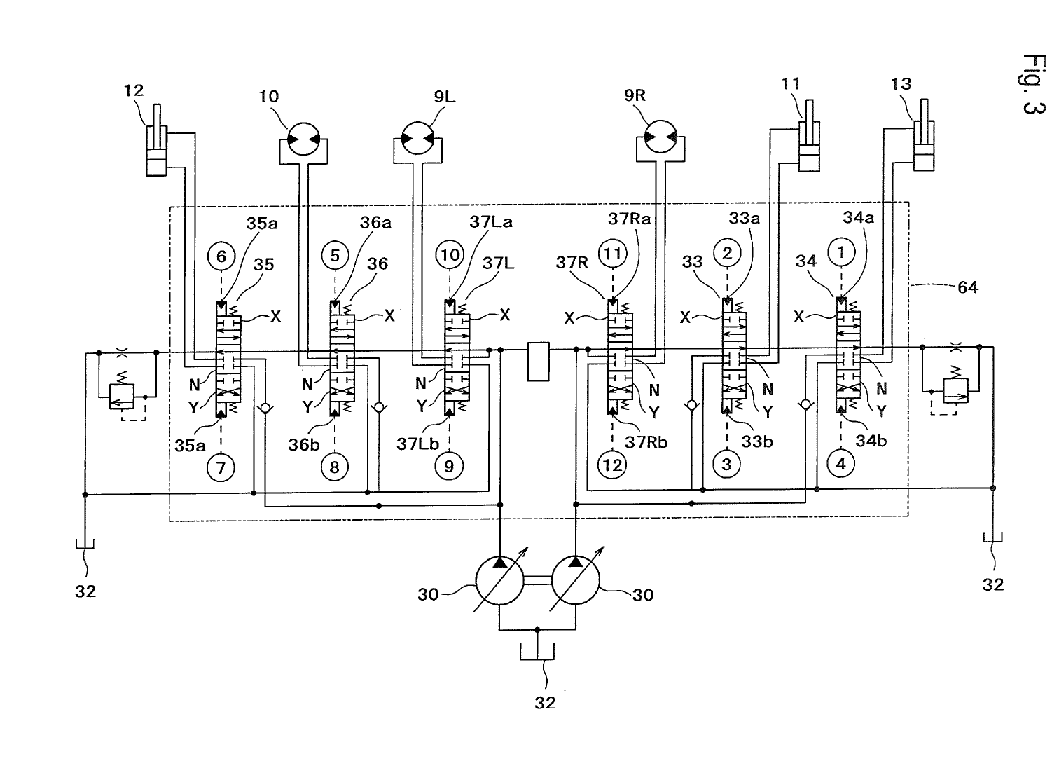

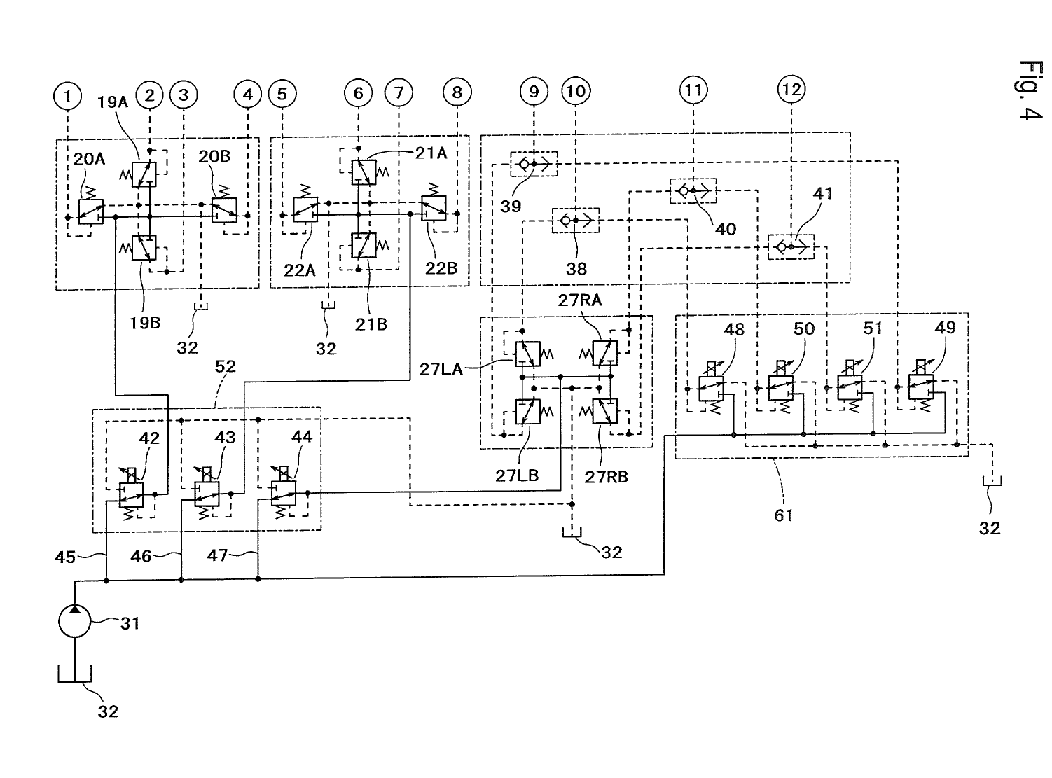

A hydraulic circuit provided in the hydraulic excavator 1 is explained with reference to hydraulic circuit diagrams of FIGS. 3 and 4. In the hydraulic circuit diagrams, reference numerals 19A and 19B to 22A and 22B denote the pilot valves for the boom, the bucket, the stick, and swing, reference numerals 27LA, 27LB, 27RA, and 27RB denote the left and right pilot valves for forward and backward traveling, reference numeral 30 denotes a main pump, which is a hydraulic source of a hydraulic actuator, reference numeral 31 denotes a pilot pump, which is a pilot hydraulic source, reference numeral 32 denotes an oil tank, reference numerals 33 to 36 denote control valves for the boom, the bucket, the stick, and the turning, and reference numerals 37L and 37R denote control valves for traveling. Note that, in FIGS. 3 and 4, encircled numbers are connector signs. The same encircles numbers are connected.

The control valves 33 to 36 for the boom, the bucket, the stick, and swing are direction switching valves of a hydraulic pilot type that respectively perform oil supply and discharge control for the boom cylinder 11, the bucket cylinder 13, the stick cylinder 12, and the swing motor 10. In a state in which a pilot pressure is not supplied to pilot ports 33a and 33b to 36a and 36b, the control valves 33 to 36 are located in a neutral position N for not performing oil supply to the hydraulic actuator. When the pilot pressure is supplied, the control valves 33 to 36 are switched to an actuation position X or Y and perform the oil supply and discharge control for driving the boom cylinder 11, the bucket cylinder 13, the stick cylinder 12, and the swing motor 10. The control valves 33 to 36 for the boom, the bucket, the stick, and swing are equivalent to a control valve for work of the present invention.

The left and right control valves for traveling 37L and 37R are direction switching valves of the hydraulic pilot type that respectively perform the oil supply and discharge control for the left and right traveling motors 9L and 9R. In a state in which the pilot pressure is not supplied to pilot ports 37La, 37Lb, 37Ra, and 37Rb on the forward traveling side and the backward traveling side, the left and right control valves for traveling 37L and 37R are located in the neutral position N for not performing oil supply to the left and right traveling motors 9R and 9R. When the pilot pressure is supplied to the pilot ports 37La and 37Ra on the forward traveling side, the left and right control valves for traveling 37L and 37R are switched to the forward traveling side actuation position X and perform the oil supply and discharge control for driving the traveling motors 9L and 9R to the forward traveling side. When the pilot pressure is supplied to the pilot ports 37Lb and 37Rb on the backward traveling side, the left and right control valves for traveling 37L and 37R are switched to the backward traveling side actuation position Y and perform the oil supply and discharge control for driving the traveling motors 9L and 9R to the backward traveling side.

In the control valves 33 to 36, 37L, and 37R for the boom, the bucket, the stick, swing, and traveling on the left and right, a spool movement amount increases and decreases according to a level of the pilot pressure supplied to the pilot ports 33a and 33b to 36a and 36b, 37La, 37Lb, 37Ra, and 37Rb. A supply flow rate to the hydraulic actuator is controlled to increase and decrease according to an increase and a decrease in the spool movement amount of the control valves 33 to 36, 37L, and 37R.

The pilot valves 19A and 19B to 22A and 22B, 27LA, 27LB, 27RA, and 27RB for the boom, the bucket, the stick, swing, and the forward and backward traveling on the left and right are actuated on the basis of operation of the left and right joystick levers 17L and 17R and the left and right operation tools for traveling 18L and 18R as explained above and respectively output the pilot pressure to the pilot ports 33a and 33b to 36a and 36b, 37La, 37Lb, 37Ra, and 37Rb of the control valves 33 to 36, 37L and 37R for the boom, the bucket, the stick, swing, and the traveling on the left and right. Inlet sides of the pilot valves 19A and 19B to 22A and 22B, 27LA, 27LB, 27RA, and 27RB are connected to a pilot pump 31, which is a pilot hydraulic source.

Note that the pilot pressure output from the left and right pilot valves for forward and backward traveling 27LA, 27LB, 27RA, and 27RB reaches the pilot ports 37La, 37Lb, 37Ra, and 37Rb of the left and right control valves for traveling 37L and 37R through first to fourth shuttle valves 38 to 41. The first to fourth shuttle valves 38 to 41 are explained below.

Further, in the hydraulic circuit diagrams, reference numerals 42 to 44 denote first to third electromagnetic valves actuated on the basis of a control command from the control apparatus 23. The first electromagnetic valve 42 is arranged in a first pilot pump oil path 45 that extends from the pilot pump 31 to an inlet side of the pilot valves 19A and 19B for the boom and the pilot valves 20A and 20B for the bucket. The second electromagnetic valve 43 is arranged in a second pilot pump oil path 46 that extends from the pilot pump 31 to an inlet side of the pilot valves 21A and 21B for the stick and the pilot valves 22A and 22B for swing. The third electromagnetic valve 44 is arranged in a third pilot pump oil path 47 that extends from the pilot pump 31 to an inlet side of the left and right pilot valves for forward and backward traveling 27LA, 27LB, 27RA, and 27RB. In a state in which the control command is not output from the control apparatus 23, the first to third electromagnetic valves 42 to 44 are in an un-actuated state for supplying pressure oil of the pilot pump 31 to the pilot valves 19A and 19B to 22A and 22B, 27LA, 27LB, 27RA, and 27RB for the boom, the bucket, the stick, swing, and the forward and backward traveling on the left and right. When the control command is output from the control apparatus 23, the first to third electromagnetic valves 42 to 44 are actuated and change to a hydraulic source shutoff state for shutting off the pressure oil supply from the pilot pump 31 to the pilot valves 19A and 19B to 22A and 22B, 27LA, 27LB, 27RA, and 27RB for the boom, the bucket, the stick, swing, and the forward and backward traveling on the left and right. In the un-actuated state of the first to third electromagnetic valves 42 to 44, the pressure oil is supplied to the inlet side of the pilot valves 19A and 19B to 22A and 22B, 27LA, 27LB, 27RA, and 27RB for the boom, the bucket, the stick, swing, and the forward and backward traveling on the left and right from the pilot pump 31. Therefore, when the left and right joystick levers 17L and 17R and the left and right operation tools for traveling 18L and 18R are operated, the pilot pressure is output from the pilot valves 19A and 19B to 22A and 22B, 27LA, 27LB, 27RA, and 27RB for the boom, the bucket, the stick, swing, and the forward and backward traveling on the left and right on the basis of the operation. Consequently, the control valves 33 to 36, 37L, and 37R for the boom, the bucket, the stick, the turning, and the traveling on the left and right are switched to the actuation position X or Y. The pressure oil is supplied to the hydraulic actuators. On the other hand, in the hydraulic source shutoff state of the first to third electromagnetic valves 42 to 44, the pressure oil is not supplied to the inlet side of the pilot valves 19A and 19B to 22A and 22B, 27LA, 27LB, 27RA, and 27RB for the boom, the bucket, the stick, the swing, and the forward and backward traveling on the left and right from the pilot pump 31. Consequently, even if the left and right joystick levers 17L and 17R and the left and right operation tools for traveling 18L and 18R are operated, the pilot pressure is not output from the pilot valves 19A and 19B to 22A and 22B, 27LA, 27LB, 27RA, and 27RB for the boom, the bucket, the stick, the swing, and the forward and backward traveling on the left and right. Therefore, the control valves 33 to 36, 37L, and 37R are retained in the neural position N to prevent the pressure oil from being supplied to the hydraulic actuators.

That is, in the un-actuated state of the first to third electromagnetic valves 42 to 44, it is possible to perform hydraulic pilot operation for driving the boom cylinder 11, the bucket cylinder 13, the stick cylinder 12, the swing motor 10, and the left and right traveling motors 9L and 9R on the basis of the output of the pilot pressure from the pilot valves 19A and 19B to 22A and 22B, 27LA, 27LB, 27RA, and 27RB for the boom, the bucket, the stick, swing, and the forward and backward traveling on the left and right involved in the operation of the left and right joystick levers 17L and 17R and the left and right operation tools for traveling 18L and 18R. On the other hand, the first to third electromagnetic valves 42 to 44 are switched to the hydraulic source shutoff state on the basis of the control signal from the control apparatus 23, whereby the first to third electromagnetic valves 42 to 44 change to a hydraulic pilot operation prohibited state in which the hydraulic pilot operation cannot be performed. The first and second electromagnetic valves 42 and 43 are equivalent to an electromagnetic valve for prohibiting pilot operation for work of the present invention. The third electromagnetic valve 44 is equivalent to an electromagnetic valve for prohibiting pilot operation for traveling of the present invention.

Further, in the hydraulic circuit diagrams, reference numerals 48 to 51 denote first to fourth electromagnetic proportional valves actuated on the basis of the control command from the control apparatus 23. An inlet side of the first to fourth electromagnetic proportional valves 48 to 51 is connected to the pilot pump 31. An outlet side is connected to the forward traveling side and backward traveling side pilot ports 37La, 37Lb, 37Ra, and 37Rb of the left and right control valves for traveling 37L and 37R through the first to fourth shuttle valves 38 to 41. The first to fourth electromagnetic proportional valves 48 to 51 are in an un-actuated state for not outputting the pilot pressure in the state in which the control command is not output from the control apparatus 23. When the control command is output from the control apparatus 23, the first to fourth electromagnetic proportional valves 48 to 51 change to an actuated state for outputting pilot pressure. The pilot pressure output from the first electromagnetic proportional valve 48 is supplied to the forward traveling side pilot port 37La of the left control valve for traveling 37L. The pilot pressure output from the second electromagnetic proportional valve 49 is supplied to the backward traveling side pilot port 37Lb of the left control valve for traveling 37L. The pilot pressure output from the third electromagnetic proportional valve 50 is supplied to the forward traveling side pilot port 37Ra of the right control valve for traveling 37R. The pilot pressure output from the fourth electromagnetic proportional valve 51 is supplied to the backward traveling side pilot port 37Rb of the right control valve for traveling 37R. Note that the first to fourth electromagnetic proportional valves 48 to 51 are equivalent to an electromagnetic proportional valve for electric operation of the present invention.

On the other hand, the first shuttle valve 38 selects a higher pressure of an output pressure from the left pilot valve for forward traveling 27LA and an output pressure from the first electromagnetic proportional valve 48 and outputs the output pressure to the forward traveling side pilot port 37La of the left control valve for traveling 37L. The second shuttle valve 39 selects a higher pressure of an output pressure from the left pilot valve for backward traveling 27LB and an output pressure from the second electromagnetic proportional valve 49 and outputs the output pressure to the backward traveling side pilot port 37Lb of the left control valve for traveling 37L. The third shuttle valve 40 selects a higher pressure of an output pressure from the right pilot valve for forward traveling 27RA and an output pressure from the third electromagnetic proportional valve 50 and outputs the output pressure to the forward traveling side pilot port 37Ra of the right control valve for traveling 37R. The fourth shuttle valve 41 selects a higher pressure of an output pressure from the right pilot valve for backward traveling 27RB and an output pressure from the fourth electromagnetic proportional valve 51 and outputs the output pressure to the backward traveling side pilot port 37Rb of the right control valve for traveling 37R. Therefore, the pilot pressure output from the left and right pilot valves for forward and backward traveling 27LA, 27LB, 27RA, and 27RB or the first to fourth electromagnetic proportional valves 48 to 51 is guided to the forward traveling side and backward traveling side pilot ports 37La, 37Lb, 37Ra, and 37Rb of the left and right control valves for traveling 37L and 37R through the first to fourth shuttle valves 38 to 41.

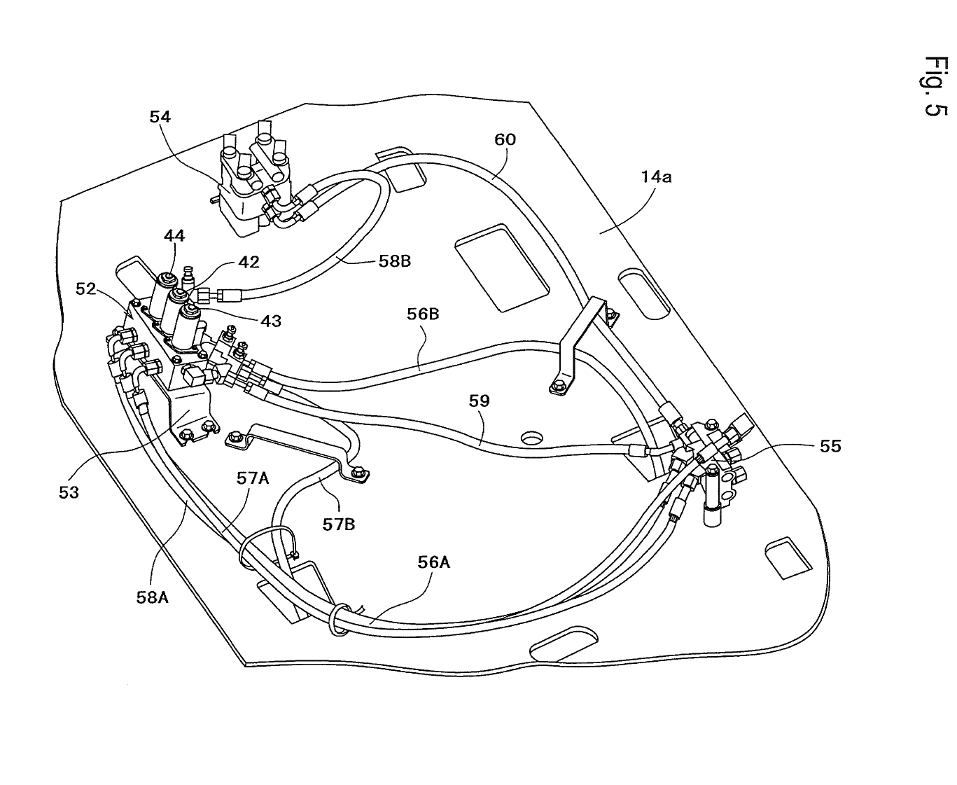

As shown in FIG. 5, the first to third electromagnetic valves 42 to 44 are integrally assembled in a triple connection state as an electromagnetic valve unit 52. The electromagnetic valve unit 52 is attached to the lower surface of an operator's cab floor 14a via an attachment bracket 53. Note that, in FIG. 5, reference numeral 54 denotes a pilot valve unit for traveling in which the left and right pilot valves for forward and backward traveling 27LA, 27LB, 27RA, and 27RB are integrally assembled and reference numeral 55 denotes a relay block for distributing the pressure oil from the pilot pump 31 and joining return oil to an oil tank 32. The pilot valve unit for traveling 54 and the relay block 55 are disposed on the lower surface of the operator's cab floor 14a. Reference numeral 56A denotes a hose for supplying the pressure oil output from the pilot pump 31 to the first electromagnetic valve 42 through the relay block 55 and reference numeral 56B denotes a hose for supplying the pressure oil output from the first electromagnetic valve 42 to the pilot valves 19A and 19B for the boom and the pilot valves 20A and 20B for the bucket. The hoses 56A and 56B form the first pilot pump oil path 45. Reference numeral 57A denotes a hose for supplying the pressure oil output from the pilot pump 31 to the second electromagnetic valve 43 through the relay block 55 and reference numeral 57B denotes a hose for supplying the pressure oil output from the second electromagnetic valve 43 to the pilot valves 21A and 21B for the stick and the pilot valves 22A and 22B for swing. The pipes 57A and 57B form the second pilot pump oil path 46. Reference numeral 58A denotes a hose for supplying the pressure oil output from the pilot pump 31 to the third electromagnetic valve 44 through the relay block 55 and reference numeral 58B denotes a hose for supplying the pressure oil output from the third electromagnetic valve 44 to the pilot valve unit for traveling 54. The hoses 58A and 58B form the third pilot pump oil path 47. Reference numerals 59 and 60 denote hoses for feeding return oil from the electromagnetic valve unit 52 and the pilot valve unit for traveling 54 to the oil tank 32 through the relay block 55. Note that FIG. 5 is a figure viewed from below the operator's cab floor 14a.

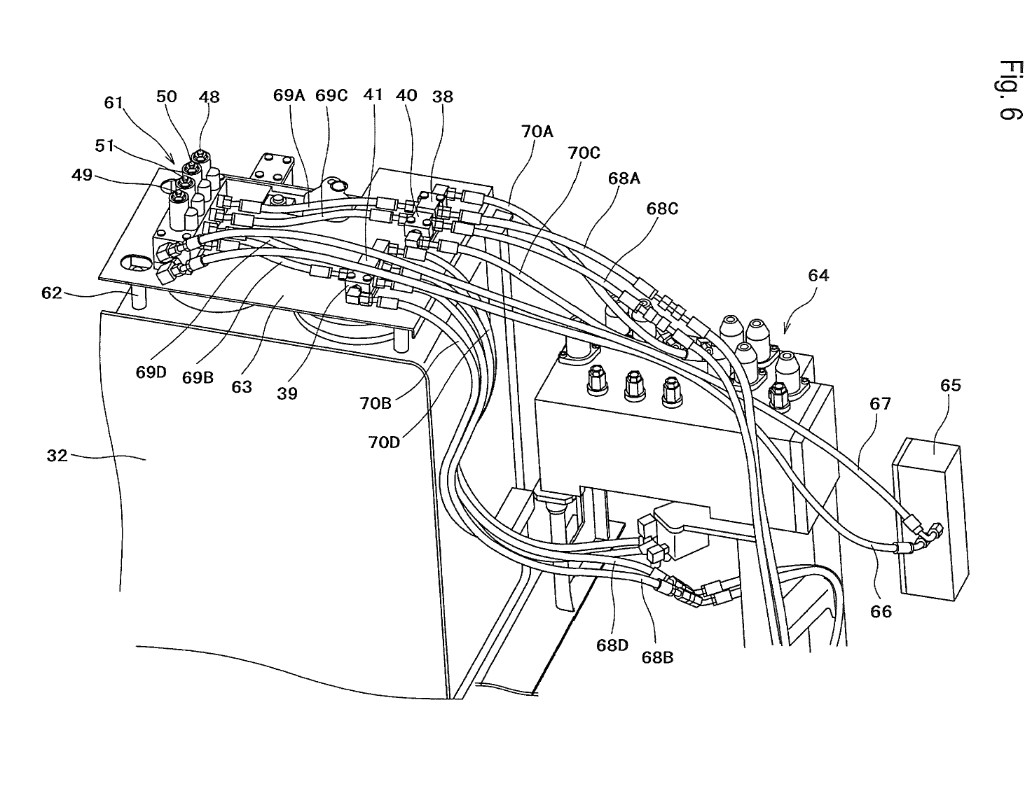

As shown in FIG. 6, the first to fourth electromagnetic proportional valves 48 to 51 are integrally assembled in a quadruple connection state as an electromagnetic proportional valve unit 61. The first to fourth shuttle valves 38 to 41 are assembled such that two of which form a pair. The electromagnetic proportional valve unit 61 and the first to fourth shuttle valves 38 to 41 are disposed on the attachment plate 63 attached and supported on the upper surface of the oil tank 32 via a spacer 62. Note that, in FIG. 6, reference numeral 64 denotes a control valve unit in which the control valves 33 to 36, 37L, and 37R for the boom, the bucket, the stick, swing, and traveling on the left and right are integrally assembled and reference numeral 65 denotes a pilot manifold through which the pressure oil from the pilot pump 31 is supplied to the electromagnetic proportional valve unit 61 and return oil from the electromagnetic proportional valve unit 61 is fed to the oil tank 32. Reference numeral 66 denotes a hose for supplying the pressure oil output from the pilot pump 31 to the electromagnetic proportional valve unit 61 through the pilot manifold 65, reference numeral 67 denotes a hose for feeding the return oil from the electromagnetic proportional valve unit 61 to the oil tank 32 through the pilot manifold 65, reference numerals 68A to 68D denote hoses for supplying the pilot pressure output from the left and right pilot valves for forward and backward traveling 27LA, 27LB, 27RA, and 27RB to the first to fourth shuttle valves 38 to 41, reference numerals 69A to 69D denote hoses for supplying the pilot pressure output from the first to fourth electromagnetic proportional valves 48 to 51 to the first to fourth shuttle valves 38 to 41, and reference numerals 70A to 70D denote hoses for supplying the pilot pressure output from the first to fourth shuttle valves 38 to 41 to the forward traveling side and backward traveling side pilot ports 37La, 37Lb, 37Ra, and 37Rb of the left and right control valves for traveling 37L and 37R. Note that, in this embodiment, the operator's cab 14 is disposed on a left front section of the upper turning body 4. The oil tank 32 is disposed in the center in the front-back direction on the right side of the upper turning body 4. The control valve unit 64 is disposed on the left of the oil tank 32.

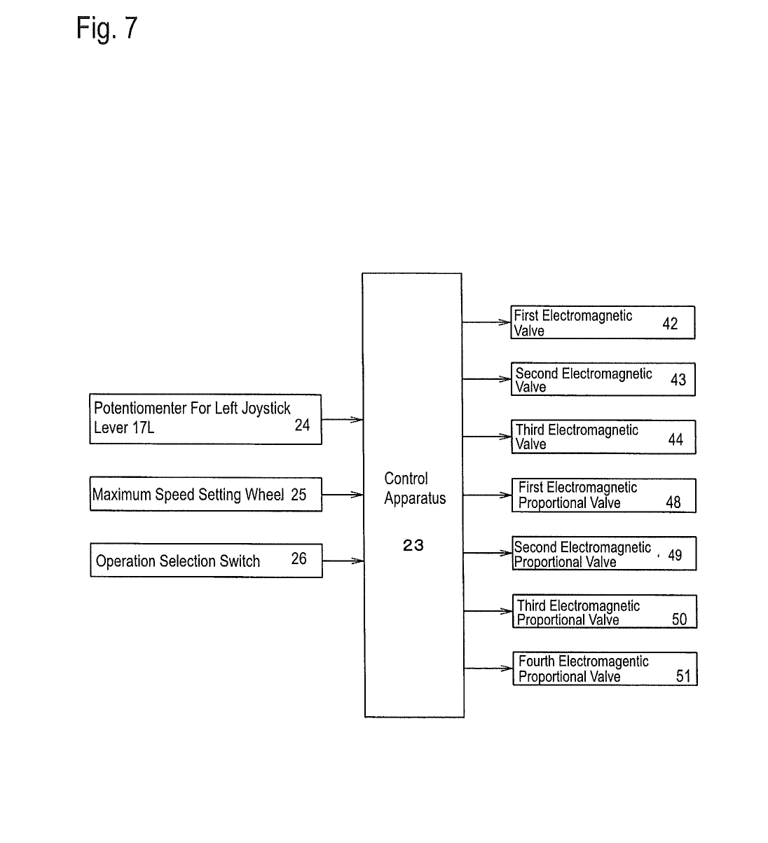

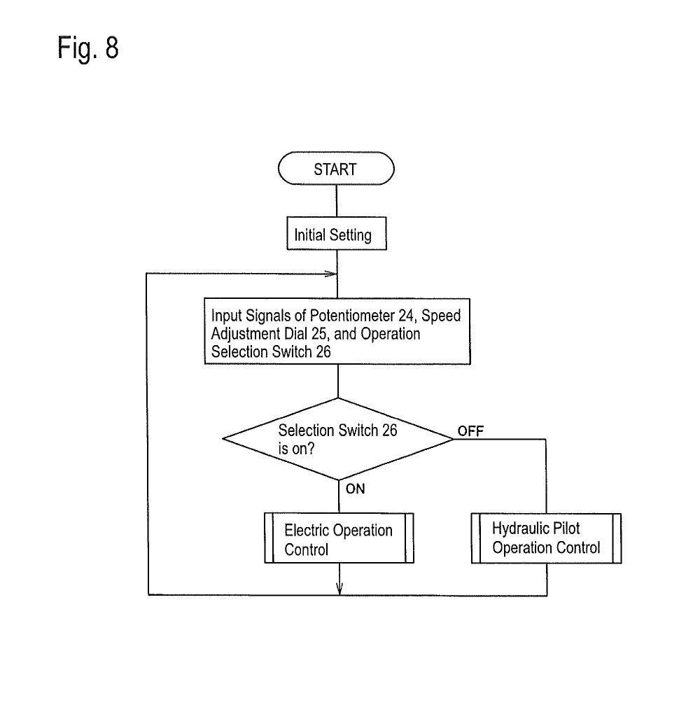

On the other hand, in the control apparatus 23, as shown in the block diagram of FIG. 7, the potentiometer 24 that detects an operation direction and an operation amount of the left joystick lever 17L, the maximum speed setting wheel 25 arranged in the left joystick lever 17L, and the operation selection switch 26 are connected to an input side. The first to third electromagnetic valves 42 to 44 and the first to fourth electromagnetic proportional valves 48 to 51 are connected to an output side. As shown in the flowchart of FIG. 8, after initial setting, when signals from the potentiometer 24, the maximum speed setting wheel 25, and the operation selection switch 26 are input, first, the control apparatus 23 determines whether the operation selection switch 26 is operated. When the operation selection switch 26 is ON (operated), the control apparatus 23 determines that the electric operation is selected by the operator and executes electric operation control explained below. On the other hand, when the operation selection switch 26 is OFF (not operated), the control apparatus 23 determines that the hydraulic pilot operation is selected by the operator and executes hydraulic pilot operation control.

First, hydraulic pilot operation control executed when the operation selection switch 26 is OFF is explained. During the execution of the hydraulic pilot operation control, the control apparatus 23 does not output the control command to the first to third electromagnetic valves 42 to 44 and the first to fourth electromagnetic proportional valves 48 to 51 irrespective of presence or absence of input signals from the potentiometer 24 and the maximum speed setting wheel 25. Consequently, the first to third electromagnetic valves 42 to 44 and the first to fourth electromagnetic proportional valves 48 to 51 are retained in the un-actuated state. As explained above, when the first to third electromagnetic valves 42 to 44 are in the un-actuated state, the pressure oil of the pilot pump 31 is supplied to the inlet side of the pilot valves 19A and 19B to 22A and 22B, 27LA, 27LB, 27RA, and 27RB for the boom, the bucket, the stick, swing, and forward and backward traveling on the left and right. When the first to fourth electromagnetic proportional valves 48 to 51 are in the un-actuated state, the pilot pressure is not output from the first to fourth electromagnetic proportional valves 48 to 51.

Therefore, during the execution of the hydraulic pilot operation control, when the left and right operation tools for traveling 18L and 18R and the left and right joystick levers 17L and 17R are operated, the pilot pressure is output from the pilot valves 19A and 19B to 22A and 22B, 27LA, 27LB, 27RA, and 27RB for the boom, the bucket, the stick, swing, and forward and backward traveling on the left and right according to the operation. It is possible to perform the hydraulic pilot operation for switching the control valves 33 to 36, 37L, and 37R for the boom, the bucket, the stick, swing, and traveling on the left and right to the actuation position X or Y with the pilot pressure and driving the boom cylinder 11, the bucket cylinder 13, the stick cylinder 12, the swing motor 10, and the left and right traveling motors 9L and 9R.

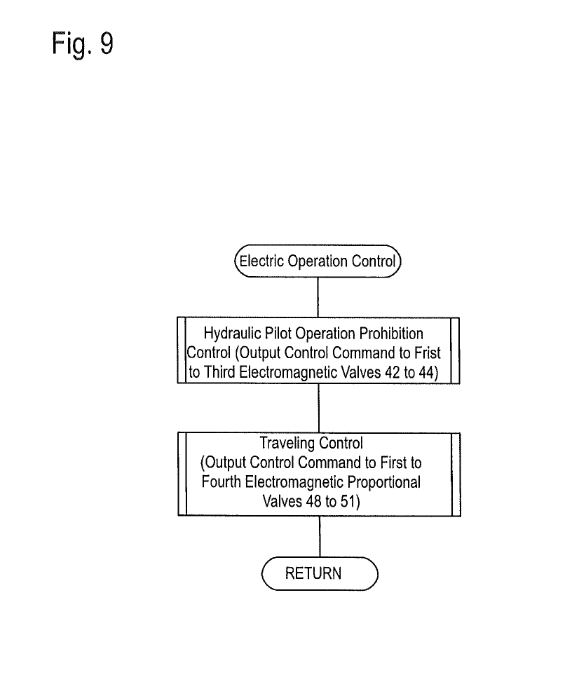

The electric operation control executed when the operation selection switch 26 is operated to be turned on is explained with reference to the flowchart of FIG. 9. In the electric operation control, first, the control apparatus 23 performs the hydraulic pilot operation prohibition control for outputting the operation command to the first to third electromagnetic valves 42 to 44 to be switched to the hydraulic source shutoff state for shutting off the pressure oil supply from the pilot pump 31 to the pilot valves 19A and 19B to 22A and 22B, 27LA, 27LB, 27RA, and 27RB for the boom, the bucket, the stick, swing, and forward and backward traveling on the left and right. Consequently, even if the left and right joystick levers 17L and 17R and the left and right operation tools for traveling 18L and 18R are operated, the pilot pressure is not output from the pilot valves 19A and 19B to 22A and 22B, 27LA, 27LB, 27RA, and 27RB. Therefore, the control apparatus 23 cannot perform the hydraulic pilot operation for driving the boom cylinder 11, the bucket cylinder 13, the stick cylinder 12, the swing motor 10, and the left and right traveling motors 9L and 9R on the basis of the output of the pilot pressure from the pilot valves 19A and 19B to 22A and 22B, 27LA, 27LB, 27RA, and 27RB. That is, the control apparatus 23 is controlled to change to the hydraulic pilot operation prohibition state in which the hydraulic pilot operation cannot be performed during the execution of the electric operation control.

Further, during the execution of the electric operation control, the control apparatus 23 performs the traveling control for outputting the control command for a pilot pressure output to the first to fourth electromagnetic proportional valves 48 to 51 on the basis of an operation direction and an operation amount of the left joystick lever 17L detected by the potentiometer 24. The pilot pressure output from the first to fourth electromagnetic proportional valves 48 to 51 according to the control command from the control apparatus 23 is guided to the forward traveling side and backward traveling side pilot ports 37La, 37Lb, 37Ra, and 37Rb of the left and right control valve for traveling 37L and 37R through the first to fourth shuttle valves 38 to 41 and switches the left and right control valves for traveling 37L and 37R to the forward traveling direction actuation position X or the backward traveling direction actuation position Y. Consequently, the left and right traveling motors 9L and 9R are driven in a forward or backward traveling direction. The left and right traveling apparatuses 2L and 2R are in turn driven to the forward or backward traveling direction. That is, when the control command for the pilot pressure output is output to the first electromagnetic proportional valve 48, the left traveling apparatus 2L is driven in the forward traveling direction. When the control command for the pilot pressure output is output to the second electromagnetic proportional valve 49, the left traveling apparatus 2L is driven in the backward traveling direction. When the control command for the pilot pressure output is output to the third electromagnetic proportional valve 50, the right traveling apparatus 2R is driven in the forward traveling direction. When the control command for the pilot pressure output is output to the fourth electromagnetic proportional valve 51, the right traveling apparatus 2R is driven in the backward traveling direction. The driving of the left and right traveling apparatuses 2L and 2R is performed on the basis of the operation of the left joystick lever 17L functioning as the electric operation device for traveling. Therefore, during the execution of the electric operation control, the electric control for driving the left and right traveling apparatuses 2L and 2R on the basis of the operation of the left joystick lever 17L (the electric operation device for traveling) is performed.

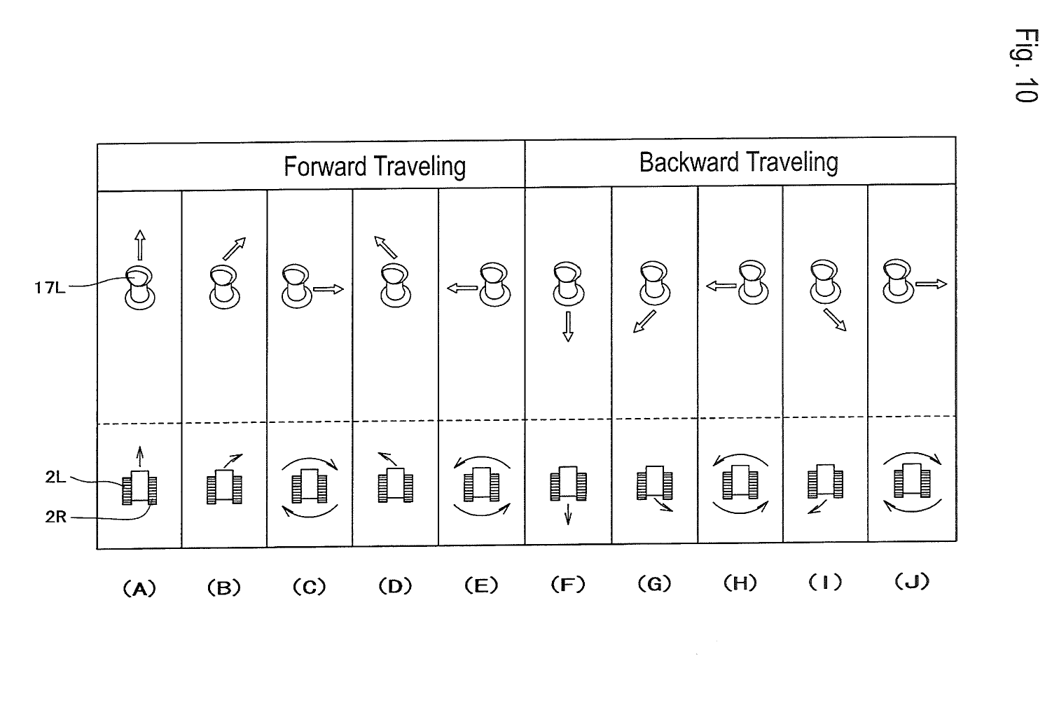

A relation among the operation of the left joystick lever 17L in the traveling control, the control command to the first to fourth electromagnetic proportional valves 48 to 51, and the traveling direction of the hydraulic excavator 1 is explained with reference to FIG. 10.

First, the relation in the case of forward traveling of the hydraulic excavator 1 is explained with reference to FIGS. 10(A) to 10(E).

As shown in FIG. 10(A), when the left joystick lever 17L is operated to the front, the control command is output to the first and third electromagnetic proportional valves 48 and 50 to output the pilot pressure of the same pressure. Consequently, the left and right traveling apparatuses 2L and 2R are driven forward at the same speed and the hydraulic excavator 1 travels straight forward.

As shown in FIG. 10(B), when the left joystick lever 17L is operated to an angle of 45 degrees on the front right, the control command for pilot pressure output is output to the first electromagnetic proportional valve 48. Consequently, the left traveling apparatus 2L is driven forward and the hydraulic excavator 1 travels forward and pivot-turns to the right. Note that, when the left joystick lever 17L is operated closer to the front than to an angle of 45 degrees on the front right, together with the control command for the pilot pressure output to the first electromagnetic proportional valve 48, a control command for pilot pressure smaller than the pressure of the first electromagnetic proportional valve 48 is output to the third electromagnetic proportional valve 50. Consequently, the right traveling apparatus 2R is driven forward traveling at a speed lower than the speed of the left traveling apparatus 2L and the hydraulic excavator 1 turns to the right while moving forward. When the left joystick lever 17L is operated closer to the right than the angle of 45 degrees on the front right, together with the control command for the pilot pressure output to the first electromagnetic proportional valve 48, a control command for pilot pressure smaller than the pressure of the first electromagnetic proportional valve 48 is output to the fourth electromagnetic proportional valve 51. Consequently, the right traveling apparatus 2R is driven backward at a speed lower than the speed of the left traveling apparatus 2L and the hydraulic excavator 1 spin-turns to the right while traveling forward.

As shown in FIG. 10(C), when the left joystick lever 17L is operated to the right, the control command is output to the first and fourth electromagnetic proportional valves 48 and 51 to output pilot pressure of the same pressure. Consequently, the left traveling apparatus 2L is driven forward, the right traveling apparatus 2R is driven backward at the same speed, and the hydraulic excavator 1 spin-turns to the right on the spot.

As shown in FIG. 10(D), when the left joystick lever 17L is operated to an angle of 45 degrees on the front left, the control command for pilot pressure output is output to the third electromagnetic proportional valve 50. Consequently, the right traveling apparatus 2R is driven forward and the hydraulic excavator 1 travels forward and pivot-turns to the left. Note that when the left joystick lever 17L is operated closer to the front than the angle of 45 degrees on the front left, together with the control command for the pilot pressure output to the third electromagnetic proportional valve 50, a control command for pilot pressure smaller than the pressure of the third electromagnetic proportional valve 50 is output to the first electromagnetic proportional valve 48. Consequently, the left traveling apparatus 2L is driven forward at a speed lower than the speed of the right traveling apparatus 2R and the hydraulic excavator 1 turns to the left while traveling forward. When the left joystick lever 17L is operated closer to the left than the angle of 45 degrees on the front left, together with the control command for the pilot pressure output to the third electromagnetic proportional valve 50, a control command for pilot pressure smaller than the pressure of the third electromagnetic proportional valve 50 is output to the second electromagnetic proportional valve 49. Consequently, the left traveling apparatus 2L is driven backward at a speed lower than the speed of the right traveling apparatus 2R and the hydraulic excavator 1 spin-turns to the left while traveling forward.

As shown in FIG. 10(E), when the left joystick lever 17L is operated to the left, a control command is output to the second and third electromagnetic proportional valves 49 and 50 to output pilot pressure of the same pressure. Consequently, the left traveling apparatus 2L is driven backward, the right traveling apparatus 2R is driven forward at the same speed, and the hydraulic excavator 1 spin-turns to the left on the spot.

The relation in the case of backward traveling of the hydraulic excavator 1 is explained with reference to FIGS. 10(F) to 10(J).

As shown in FIG. 10(F), when the left joystick lever 17L is operated to the back, a control command is output to the second and fourth electromagnetic proportional valves 49 and 51 to output pilot pressure of the same pressure. Consequently, the left and right traveling apparatuses 2L and 2R are driven backward at the same speed and the hydraulic excavator 1 travels straight backward.

As shown in FIG. 10(G), when the left joystick lever 17L is operated to an angle of 45 degrees on the back left, a control command for pilot pressure output is output to the second electromagnetic proportional valve 49. Consequently, the left traveling apparatus 2L is driven backward and the hydraulic excavator 1 travels backward and pivot-turns to the right. Note that when the left joystick lever 17L is operated closer to the back than the angle of 45 degrees on the back left, together with the control command for the pilot pressure output to the second electromagnetic proportional valve 49, a control command for pilot pressure smaller than the pressure of the second electromagnetic proportional valve 49 is output to the fourth electromagnetic proportional valve 51. Consequently, the right traveling apparatus 2R is driven backward at a speed lower than the speed of the left traveling apparatus 2L and the hydraulic excavator 1 turns to the right while traveling backward. When the left joystick lever 17L is operated closer to the left than the angle of 45 degrees on the back left, together with the control command for the pilot pressure output to the second electromagnetic proportional valve 49, a control command for pilot pressure smaller than the second electromagnetic proportional valve 49 is output to the third electromagnetic proportional valve 50. Consequently, the right traveling apparatus 2R is driven forward at speed lower than the speed of the left traveling apparatus 2L and the hydraulic excavator 1 spin-turns to the right while traveling backward.

As shown in FIG. 10(H), when the left joystick lever 17L is operated to the left, a control command is output to the second and third electromagnetic proportional valves 49 and 50 to output pilot pressure of the same pressure. Consequently, the left traveling apparatus 2L is driven backward, the right traveling apparatus 2R is driven forward at the same speed, and the hydraulic excavator 1 spin-turns on the spot. A spin turn to the right in the backward traveling direction is in the same direction as a spin turn to the left in the forward traveling direction.

As shown in FIG. 10(I), when the left joystick lever 17L is operated to an angle of 45 degrees on the back right, a control command for pilot pressure output is output to the fourth electromagnetic proportional valve 51. Consequently, the right traveling apparatus 2R is driven backward and the hydraulic excavator 1 travels backward and pivot-turns to the left. Note that when the left joystick lever 17L is operated closer to the back than the angle of 45 degrees on the back right, together with the control command for the pilot pressure output to the fourth electromagnetic proportional valve 51, a control command for pilot pressure smaller than the pressure of the fourth electromagnetic proportional valve 51 is output to the second electromagnetic proportional valve 49. Consequently, the left traveling apparatus 2L is driven backward at a speed lower than the speed of the right traveling apparatus 2R and the hydraulic excavator 1 turns to the left while traveling backward. When the left joystick lever 17L is operated closer to the right than the angle of 45 degrees on the back right, together with the control command for the pilot pressure output to the fourth electromagnetic proportional valve 51, a control command for pilot pressure smaller than the pressure of the fourth electromagnetic proportional valve 51 is output to the first electromagnetic proportional valve 48. Consequently, the left traveling apparatus 2L is driven forward at a speed lower than the speed of the right traveling apparatus 2R and the hydraulic excavator 1 spin-turns to the left while traveling backward.

As shown in FIG. 10(J), when the left joystick lever 17L is operated to the right, a control command is output to the first and fourth electromagnetic proportional valves 48 and 51 to output pilot pressure of the same pressure. Consequently, the left traveling apparatus 2L is driven forward, the right traveling apparatus 2R is driven backward at the same speed, and the hydraulic excavator 1 spin-turns to the left on the spot. Note that a spin-turn to the left in the backward traveling direction is in the same direction as a spin turn to the right in the forward traveling direction.

Note that, as explained above, the left joystick lever 17L functions as the electric operation device for traveling only during the execution of the electric operation control, that is, while the operation selection switch 26 is pushed.

Further, the control apparatus 23 also performs control of traveling speed in the traveling control. In this case, the control apparatus 23 calculates traveling speed V (%) (V=T×A) by multiplying together an operation amount T (%) of the left joystick lever 17L detected by the potentiometer 24 (percentage at the time when a maximum operation amount of the left joystick lever 17L is set to 100%) and a setting value A (%) of the maximum speed setting wheel 25. Consequently, the traveling speed is calculated such that the traveling speed is higher as the operation amount T of the left joystick lever 17L is larger and the maximum traveling speed changes according to the setting value A of the maximum speed setting wheel 25. The pilot pressure output from the first to fourth electromagnetic proportional valves 48 to 51 is increased and reduced according to the calculated traveling speed to increase and reduce a pressure oil supply flow rate to the left and right traveling motors 9L and 9R. Consequently, the left and right traveling apparatuses 2L and 2R are controlled to travel at a speed corresponding to the calculated traveling speed.

In this embodiment configured as explained above, the hydraulic excavator 1 includes left and right traveling motors 9L and 9R that drive the left and right traveling apparatuses 2L and 2R, left and right control valves for traveling 37L and 37R of the hydraulic pilot type that perform oil supply and discharge control for the left and right traveling motors 9L and 9R, and left and right traveling operation tools 18L and 18R that actuate the left and right forward and backward traveling pilot valves 27LA, 27LB, 27RA, and 27RB that in turn output pilot pressure to the left and right control valves for traveling 37L and 37R. In the hydraulic excavator 1, the potentiometer 24 is annexed to the left joystick lever 17L to enable use of the left joystick lever 17L as the electric operation device that outputs the electric signal for traveling. In configuring the hydraulic excavator 1 to be capable of selecting between hydraulic pilot operation for controlling traveling apparatuses 2L and 2R on the basis of the operation of the operation tools for traveling 18L and 18R and electric operation on the basis of the operation of the electric device for traveling (the left joystick lever 17L), the hydraulic excavator 1 is provided with operation selection switch 26, control apparatus 23 that receives the electric signal for traveling from the left joystick lever 17L and the selection signal from the operation selection switch 26, third electromagnetic valve 44 that prohibits an output of pilot pressure from the pilot valves for forward and backward traveling 27LA, 27LB, 27RA, and 27RB to the control valves for traveling 37L and 37R on the basis of the control signal from the control apparatus 23, the first to fourth electromagnetic proportional valves 48 to 51 that output pilot pressure to the control valves for traveling 37L and 37R on the basis of a control signal from the control apparatus 23, and first to fourth shuttle valves 38 to 41 that guide, to the control valves for traveling 37L and 37R, the pilot pressure output from either the pilot valves for forward and backward traveling 27LA, 27LB, 27RA, and 27RB or the first to fourth electromagnetic proportional valves 48 to 51.

When the hydraulic pilot operation is selected by the operation selection switch 26, the control command is not output from the control apparatus 23 to the third electromagnetic valve 44 and the first to fourth electromagnetic proportional valves 48 to 51. Therefore, the output of the pilot pressure from the pilot valves for forward and backward traveling 27LA, 27LB, 27RA, and 27RB to the control valves for traveling 37R and 37L is allowed. There is no output from the first to fourth electromagnetic proportional valves 48 to 51 to the control valves for traveling 37R and 37L. Therefore, hydraulic pilot operation for driving the traveling apparatuses 2L and 2R on the basis of the operation of the operation tools for traveling 18L and 18R is performed. On the other hand, when the electric operation is selected by the operation selection switch 26, the control command is output from the control apparatus 23 to the third electromagnetic valve 44 to the first to fourth electromagnetic proportional valves 48 to 51. The output of the pilot pressure from the pilot valves for forward and backward traveling 27LA, 27LB, 27RA, and 27RB to the control valves for traveling 37R and 37L is prevented. The pilot pressure is output from the first to fourth electromagnetic proportional valves 48 to 51 to the control valves for traveling 37R and 37L on the basis of the operation of the electric operation device for traveling (the left joystick lever 17L). Therefore, electric operation for driving the traveling apparatuses 2L and 2R on the basis of the operation of an electric operation device for traveling is performed.

As a result, it is possible to arbitrarily select, as the traveling operation for the hydraulic excavator 1, any one of the hydraulic pilot operation and the electric operation according to types and work contents of various attachment attached to the hydraulic excavator 1, skills and preferences of operators, or the like. It is possible to meet diversified demands for operability. Moreover, in this embodiment, the left joystick lever 17L is used as the electric operation device for traveling. However, in the present invention, even if various operation tools such as a lever, a pedal, a switch, and a thumb wheel other than the left joystick lever 17L are used as the electronic operation device for traveling, it is possible to select the hydraulic pilot operation and the electric operation with entirely the same configuration except that only the electric operation device for traveling is different. Therefore, it is possible to perform traveling operation using various operation tools and attain further diversification of the traveling operation.

Further, the hydraulic excavator 1 includes the hydraulic actuator for work (in this embodiment, the boom cylinder 11, the bucket cylinder 13, the stick cylinder 12, and the swing motor 10), the control valves for work (in this embodiment, the control valves for the boom, the bucket, the stick, and the swing) 33 to 36 of the hydraulic pilot type that perform the oil supply and discharge control for the hydraulic actuator for work, the pilot valves for work (in this embodiment, the pilot valves for the boom, the bucket, the stick, and the swing) 19A and 19B to 22A and 22B that output the pilot pressure to the control valves for work 33 to 36, and the left and right joystick levers 17L and 17R. One left joystick lever 17L of the left and right joystick levers 17L and 17R has the function of the hydraulic pilot operation tool for work that actuates the pilot valves for work 19A and 19B to 22A and 22B on the basis of lever operation, and the function of the electric operation device for traveling that outputs the electric signal for traveling to the control apparatus 23 on the basis of lever operation. The hydraulic excavator 1 is provided with the first and second electromagnetic valves 43 and 44 that prohibit an output of the pilot pressure from the pilot valves for work 19A and 19B to 22A and 22B to the control valves for work 33 to 36 on the basis of the control signal from the control apparatus 23. As a result, it is possible to directly use, as the electric operation device for traveling, the left joystick lever 17L used as the hydraulic pilot operation tool for work. It is possible to select the hydraulic pilot operation and the electric operation without separately providing the electric operation device for traveling. Note that, in this embodiment, the left joystick lever 17L is used as the electric operation device for traveling. However, it goes without saying that the right joystick lever 17R may alternatively be used.

Moreover, in the hydraulic excavator 1, operation selection switch 26 is provided in the left joystick lever 17L functioning as the electric operation device for traveling. Therefore, the operation of the electric operation device for traveling and the operation of the operation selection switch 26 can be performed by one hand. Therefore, the hydraulic excavator 1 is excellent in operability, for example, when operation tool operation other than traveling is performed by one hand.

Note that it goes without saying that the present invention is not limited to the first embodiment. As the electric operation device for traveling, various operation tools can be adopted as explained above. Specific examples of the operation tools are identified in second to fourth embodiments explained below. Note that, in the second to fourth embodiments, a hydraulic circuit is the same as the hydraulic circuit in the first embodiment. Therefore, illustration and explanation of the hydraulic circuit is omitted. Hydraulic pilot operation control and hydraulic pilot operation prohibition control performed by the control apparatus 23 are the same as the hydraulic pilot operation control and the hydraulic pilot operation prohibition control in the first embodiment. Therefore, explanation of the hydraulic pilot operation control and the hydraulic pilot operation prohibition control is omitted.

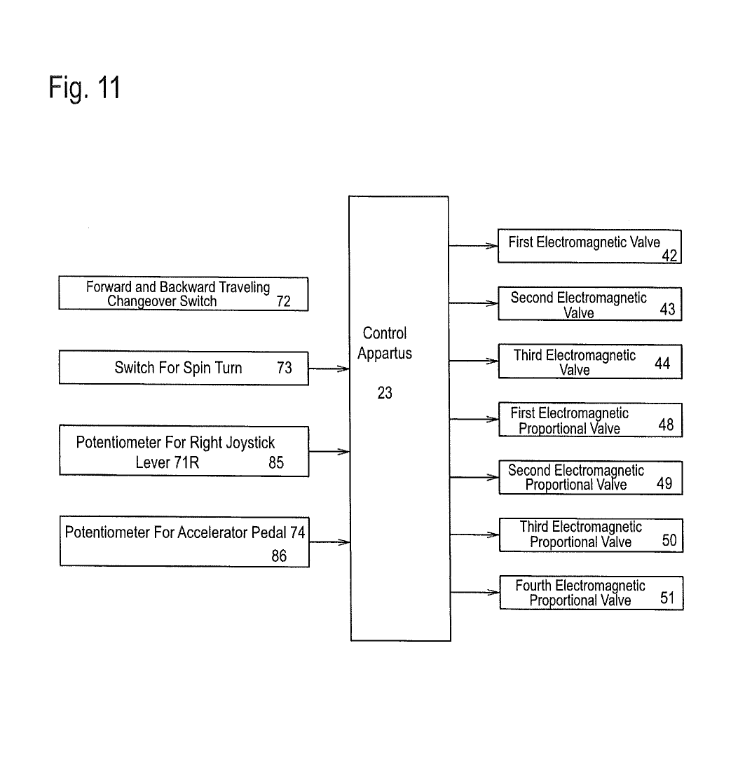

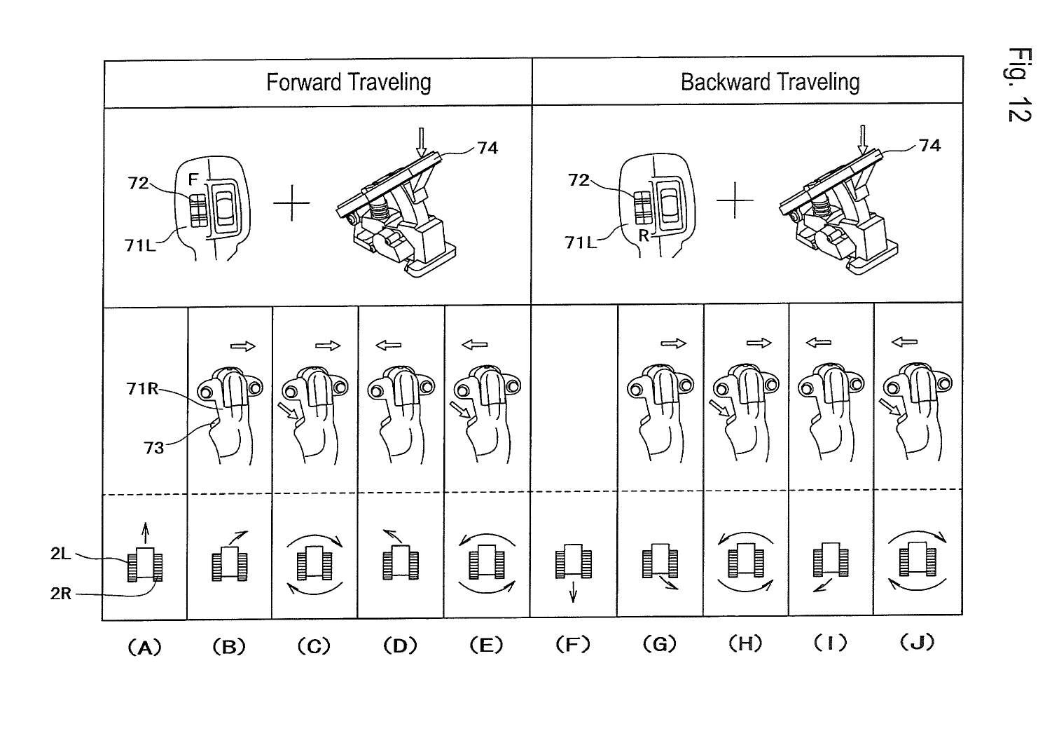

First, in the second embodiment shown in FIGS. 11 and 12, as the electric operation device that outputs electric signal for traveling, a forward and backward traveling changeover switch 72 provided on the upper surface of a gripping section of a left joystick lever 71L, a switch for spin turn 73 provided on the rear surface of a gripping section of a right joystick lever 71R, and an accelerator pedal 74 are used. As shown in the block diagram of FIG. 11, the control apparatus 23 receives signals from the forward and backward traveling changeover switch 72, the switch for spin turn 73, a potentiometer 85 that detects an operation direction of the right joystick lever 71R, and a potentiometer 86 that detects an operation amount of the accelerator pedal 74. The control apparatus 23 outputs a control command to the first to third electromagnetic valves 42 to 44 and the first to fourth electromagnetic proportional valves 48 to 51 on the basis of the input signals and performs the hydraulic pilot operation control and the electric operation control (the hydraulic pilot operation prohibition control and the traveling control) explained above. In the second embodiment, the forward and backward traveling changeover switch 72 is also used as operation selecting means for selecting the hydraulic pilot operation or the electric operation. That is, the forward and backward traveling changeover switch 72 can be changed over to positions of forward traveling F (Forward), neutral N (Neutral), and backward traveling R (Reverse). The control apparatus 23 performs the hydraulic pilot operation control when the forward and backward traveling changeover switch 72 is in the neutral N position and, on the other hand, when the forward and backward traveling changeover switch 72 is in the forward traveling F position or the backward traveling R position, performs the electric operation control using, as a selection signal, an electric signal for traveling output from the forward and backward traveling changeover switch 72.

In the second embodiment, as in the first embodiment, during the execution of the electric operation control, the control apparatus 23 performs, on the basis of an input signal from the electric operation device for traveling, traveling control for outputting a control command for a pilot pressure output to the first to fourth electromagnetic proportional valves 48 to 51. A relation among the operation of the electric operation device for traveling in the traveling control, the control command to the first to fourth electromagnetic proportional valves 48 to 51, and a traveling direction of the hydraulic excavator 1 is explained with reference to FIG. 12.

First, the relation in the case of forward traveling of the hydraulic excavator 1 is explained with reference to FIGS. 12(A) to 12(E). As shown in FIG. 12(A), when the forward and backward traveling changeover switch 72 is set in the forward traveling F position and the accelerator pedal 74 is operated, the control command is output to the first and third electromagnetic proportional valves 48 and 50 to output the pilot pressure of the same pressure. Consequently, the left and right traveling apparatuses 2L and 2R are driven to the forward traveling side at the same speed and the hydraulic excavator 1 travels straight forward.

As shown in FIG. 12(B), when the forward and backward traveling changeover switch 72 is set in the forward traveling F position, the accelerator pedal 74 is operated, and the right joystick lever 71R is operated to the right, the control command for the pilot pressure output is output to the first and third electromagnetic proportional valves 48 and 50. In this case, an output pressure from the third electromagnetic proportional valve 50 is controlled to be smaller than an output pressure of the first electromagnetic proportional valve 48 as an operation amount to the right of the right joystick lever 71R is larger. Consequently, the left traveling apparatus 2L is driven to the forward traveling side, the right traveling apparatus 2R is driven to the forward traveling side at speed lower than the speed of the left traveling apparatus 2L, and the hydraulic excavator 1 turns to the right direction while traveling forward. Note that, when the operation amount to the right of the right joystick lever 71R reaches the maximum, the control command for the pilot pressure output to the third electromagnetic proportional valve 50 is stopped. Consequently, the hydraulic excavator 1 travels forward and pivot-turns to the right direction.

As shown in FIG. 12(C), when the forward and backward traveling changeover switch 72 is set in the forward traveling F position, the accelerator pedal 74 is operated, the right joystick lever 71R is operated to the right, and the switch for spin turn 73 is pushed, the control command is output to the first and fourth electromagnetic proportional valves 48 and 51 to output the pilot pressure. Consequently, the left traveling apparatus 2L is driven forward, the right traveling apparatus 2R is driven backward, and the hydraulic excavator 1 spin-turns to the right.

As shown in FIG. 12(D), when the forward and backward traveling changeover switch 72 is set in the forward traveling F position, the accelerator pedal 74 is operated, and the right joystick lever 71R is operated to the left, the control command for the pilot pressure output is output to the first and third electromagnetic proportional valves 48 and 50. In this case, the output pressure from the first electromagnetic proportional valve 48 is controlled to be smaller than the output pressure of the third electromagnetic proportional valve 50 because an operation amount to the left of the right joystick lever 71R is larger. Consequently, the right traveling apparatus 2R is driven forward, the left traveling apparatus 2L is driven forward at a speed lower than the speed of the right traveling apparatus 2R, and the hydraulic excavator 1 turns to the left while traveling forward. Note that when the operation amount to the left of the right joystick lever 71R reaches the maximum, the control command for the pilot pressure output to the first electromagnetic proportional valve 48 is stopped. Consequently, the hydraulic excavator 1 travels forward and pivot-turns to the left.

As shown in FIG. 12(E), when the forward and backward traveling changeover switch 72 is set in the forward traveling F position, the accelerator pedal 74 is operated, the right joystick lever 71R is operated to the left, and the switch for spin turn 73 is pushed, the control command is output to the second and third electromagnetic proportional valves 49 and 50 to output pilot pressure. Consequently, the left traveling apparatus 2L is driven backward, the right traveling apparatus 2R is driven forward, and the hydraulic excavator 1 spin-turns to the left.

The relation in the case of the backward traveling of the hydraulic excavator 1 is explained with reference to FIGS. 12(F) to 12(J). As shown in FIG. 12(F), when the forward and backward traveling changeover switch 72 is set in the backward traveling R position and the accelerator pedal 74 is operated, the control command is output to the second and fourth electromagnetic proportional valves 49 and 51 to output pilot pressure of the same pressure. Consequently, the left and right traveling apparatuses 2L and 2R are driven backward at the same speed and the hydraulic excavator 1 travels straight backward.

As shown in FIG. 12(G), when the forward and backward traveling changeover switch 72 is set in the backward traveling R position, the accelerator pedal 74 is operated, and the right joystick lever 71R is operated to the right, the control command for pilot pressure output is output to the second and fourth electromagnetic proportional valves 49 and 51. In this case, an output pressure from the fourth electromagnetic proportional valve 51 is controlled to be smaller than an output pressure of the second electromagnetic proportional valve 49 as an operation amount to the right of the right joystick lever 71R is larger. Consequently, the left traveling apparatus 2L is driven backward traveling, the right traveling apparatus 2R is driven backward at a speed lower than the speed of the left traveling apparatus 2L, and the hydraulic excavator 1 turns to the right while traveling backward. Note that when the operation amount to the right of the right joystick lever 71R reaches the maximum, the control command for pilot pressure output to the fourth electromagnetic proportional valve 51 is stopped. Consequently, the hydraulic excavator 1 travels backward and pivot-turns to the right.

As shown in FIG. 12(H), when the forward and backward traveling changeover switch 72 is set in the backward traveling R position, the accelerator pedal 74 is operated, the right joystick lever 71R is operated to the right, and the switch for spin turn 73 is pushed, the control command is output to the second and third electromagnetic proportional valves 49 and 50 to output pilot pressure. Consequently, the left traveling apparatus 2L is driven backward, the right traveling apparatus 2R is driven forward, and the hydraulic excavator 1 spin-turns to the right. Note that a spin turn to the right in the backward traveling direction is in the same direction as a spin turn to the left in the forward traveling direction.

As shown in FIG. 12(I), when the forward and backward traveling changeover switch 72 is set in the backward traveling R position, the accelerator pedal 74 is operated, and the right joystick lever 71R is operated to the left, the control command for pilot pressure output is output to the second and fourth electromagnetic proportional valves 49 and 51. In this case, the output pressure from the second electromagnetic proportional valve 49 is controlled to be smaller than the output pressure of the fourth electromagnetic proportional valve 51 as an operation amount to the left of the right joystick lever 71R is larger. Consequently, the right traveling apparatus 2R is driven backward, the left traveling apparatus 2L is driven backward at a speed lower than the speed of the right traveling apparatus 2R, and the hydraulic excavator 1 turns to the left while traveling backward. Note that when the operation amount to the left of the right joystick lever 71R reaches the maximum, the control command for the pilot pressure output to the second electromagnetic proportional valve 49 is stopped. Consequently, the hydraulic excavator 1 travels backward and pivot-turns to the left.

As shown in FIG. 12(J), when the forward and backward traveling changeover switch 72 is set in the backward traveling R position, the accelerator pedal 74 is operated, the right joystick lever 71R is operated to the left, and the switch for spin turn 73 is pushed, the control command is output to the first and fourth electromagnetic proportional valves 48 and 51 to output pilot pressure. Consequently, the left traveling apparatus 2L is driven forward, the right traveling apparatus 2R is driven backward, and the hydraulic excavator 1 spin-turns to the left. Note that a spin turn to the left in the backward traveling direction is in the same direction as a spin turn to the right in the forward traveling direction.

Further, the control apparatus 23 also performs control of the traveling speed on the basis of an input signal from the potentiometer 86 that detects an operation amount of the accelerator pedal 74. That is, when the accelerator pedal 74 is not operated, irrespective of other traveling signals, the control apparatus 23 does not output the control command for pilot pressure output to the first to fourth electromagnetic proportional valves 48 to 51. Consequently, the left and right traveling apparatuses 2L and 2R stop. On the other hand, when the accelerator pedal 74 is operated, the control apparatus 23 outputs the control command for pilot pressure output to the first to fourth electromagnetic proportional valves 48 to 51 on the basis of the other traveling signals as explained above. In this case, the control apparatus 23 outputs the control command such that the output pressure from the first to fourth electromagnetic proportional valves 48 to 51 is larger as the operation amount of the accelerator pedal 74 is larger. Consequently, in the second embodiment, the traveling speed is controlled to be higher as the operation amount of the accelerator pedal 74 is larger.

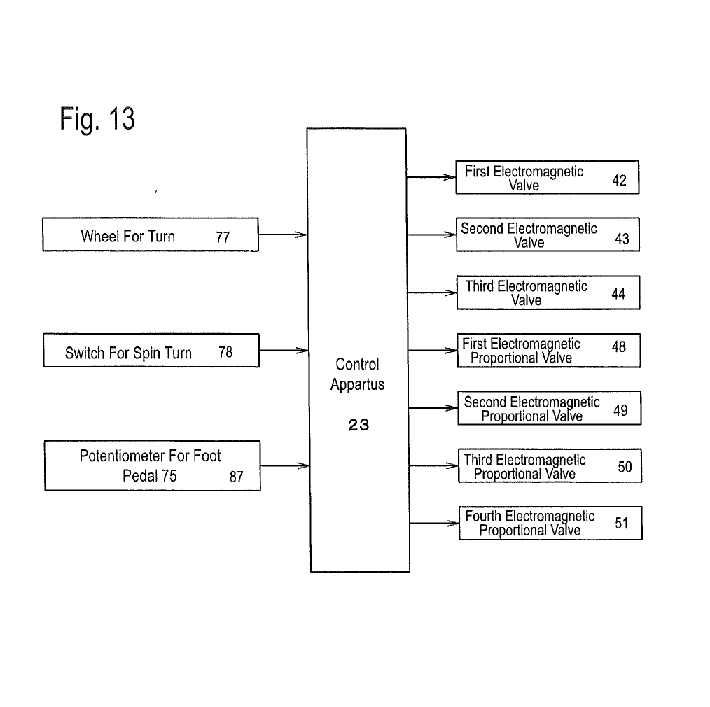

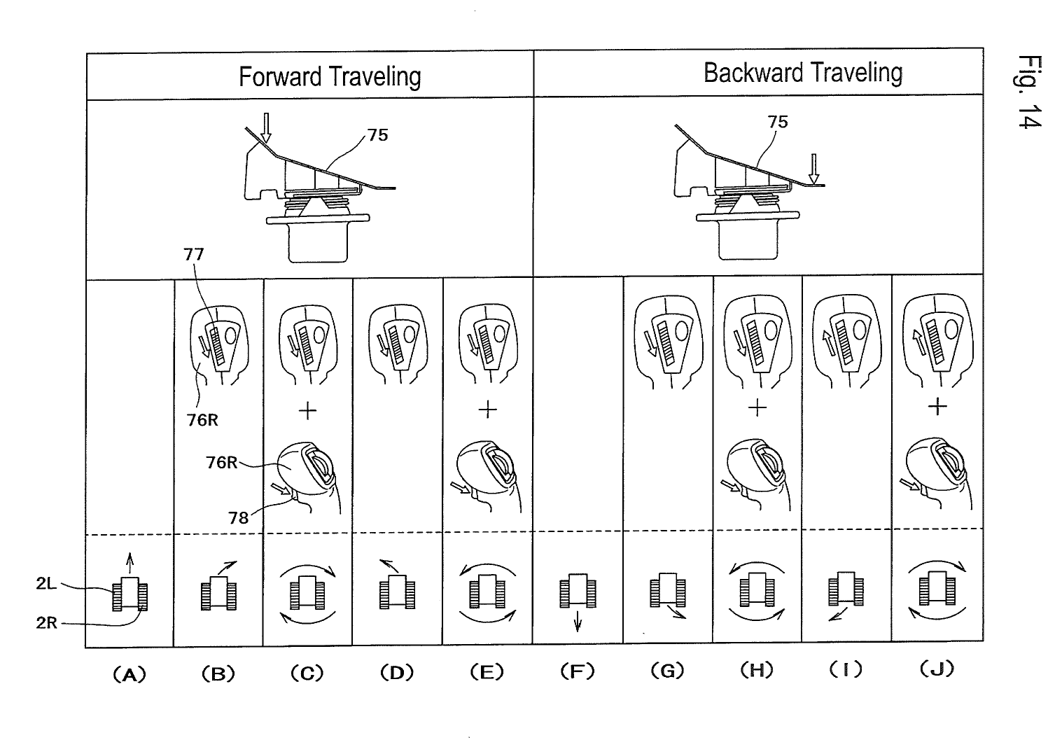

A third embodiment shown in FIGS. 13 and 14 is explained. In the third embodiment, as the electric operation device for traveling that outputs the electric signal for traveling, a foot pedal 75, a wheel for turn 77 provided on the upper surface of a right joystick lever 76R, and a switch for spin turn 78 provided on the rear surface of a gripping section of a right joystick lever 76R are used. As shown in the block diagram of FIG. 13, the control apparatus 23 receives signals from the wheel for turn 77, the switch for spin turn 78, and a potentiometer 87 that detects an operation direction and an operation amount of the foot pedal 75. The control apparatus 23 outputs the control command to the first to third electromagnetic valves 42 to 44 and the first to fourth electromagnetic proportional valves 48 to 51 on the basis of the input signals and performs the hydraulic pilot operation control and the electric operation control (the hydraulic pilot operation prohibition control and the traveling control) explained above. In the third embodiment, the foot pedal 75 is also used as operation selecting means for selecting between hydraulic pressure pilot operation and electric operation. That is, the foot pedal 75 can be operated to the front (the forward traveling F position), the back (the backward traveling R position) and a neutral position in the center. When the foot pedal 75 is in the neutral position, the control apparatus 23 performs the hydraulic pilot operation control. On the other hand, when the foot pedal 75 is operated to the forward traveling F position or the backward traveling R position, the control apparatus 23 performs the electric operation control using, as a selection signal, an electric signal for traveling output from the foot pedal 75.

In the third embodiment, as in the first and second embodiments, during the execution of the electric operation control, the control apparatus 23 performs, on the basis of an input signal from the electric operation device for traveling, traveling control for outputting a control command for a pilot pressure output to the first to fourth electromagnetic proportional valves 48 to 51. A relation among the operation of the electric operation device for traveling in the traveling control, the control command to the first to fourth electromagnetic proportional valves 48 to 51, and a traveling direction of the hydraulic excavator 1 is explained with reference to FIG. 14.

First, the relation in the case of forward traveling of the hydraulic excavator 1 is explained with reference to FIGS. 14(A) to 14(E). As shown in FIG. 14(A), when the foot pedal 75 is operated to the forward traveling F position, the control command is output to the first and third electromagnetic proportional valves 48 and 50 to output pilot pressure of the same pressure. Consequently, the left and right traveling apparatuses 2L and 2R are driven forward at the same speed and the hydraulic excavator 1 travels straight forward.

As shown in FIG. 14(B), when the foot pedal 75 is operated to the forward traveling F position and the wheel for turn 77 is turned downward, the control command for pilot pressure output is output to the first and third electromagnetic proportional valves 48 and 50. In this case, an output pressure from the third electromagnetic proportional valve 50 is controlled to be smaller than an output pressure of the first electromagnetic proportional valve 48 as the wheel for turn 77 is turned further downward. Consequently, the left traveling apparatus 2L is driven forward, the right traveling apparatus 2R is driven forward at a speed lower than the speed of the left traveling apparatus 2L, and the hydraulic excavator 1 turns to the right while traveling forward. Note that, when the wheel for turn 77 is turned to a bottom end, the control command for pilot pressure output to the third electromagnetic proportional valve 50 is stopped. Consequently, the hydraulic excavator 1 travels forward and pivot-turns to the right.

As shown in FIG. 14(C), when the foot pedal 75 is operated to the forward traveling F position, the wheel for turn 77 is turned downward, and the switch for spin turn 78 is pushed, the control command is output to the first and fourth electromagnetic proportional valves 48 and 51 to output pilot pressure. Consequently, the left traveling apparatus 2L is driven forward, the right traveling apparatus 2R is driven backward, and the hydraulic excavator 1 spin-turns to the right.

As shown in FIG. 14(D), when the foot pedal 75 is operated to the forward traveling F position and the wheel for turn 77 is turned upward, the control command for pilot pressure output is output to the first and third electromagnetic proportional valves 48 and 50. In this case, the output pressure from the first electromagnetic proportional valve 48 is controlled to be smaller than the output pressure of the third electromagnetic proportional valve 50 as the wheel for turn 77 is turned further upward. Consequently, the right traveling apparatus 2R is driven forward, the left traveling apparatus 2L is driven forward at a speed lower than the speed of the right traveling apparatus 2R, and the hydraulic excavator 1 turns to the left while traveling forward. Note that, when the wheel for turn 77 is turned to a top end, the control command for the pilot pressure output to the first electromagnetic proportional valve 48 is stopped. Consequently, the hydraulic excavator 1 travels forward and pivot-turns to the left.

As shown in FIG. 14(E), when the foot pedal 75 is operated to the forward traveling F position, the wheel for turn 77 is turned upward, and the switch for spin turn 78 is pushed, the control command is output to the second and third electromagnetic proportional valves 49 and 50 to output pilot pressure. Consequently, the left traveling apparatus 2L is driven backward, the right traveling apparatus 2R is driven forward, and the hydraulic excavator 1 spin-turns to the left.

The relation in the case of the backward traveling of the hydraulic excavator 1 is explained with reference to FIGS. 14(F) to 14(J).

As shown in FIG. 14(F), when the foot pedal 75 is operated to the backward traveling R position, the control command is output to the second and fourth electromagnetic proportional valves 49 and 51 to output pilot pressure of the same pressure. Consequently, the left and right traveling apparatuses 2L and 2R are driven backward at the same speed and the hydraulic excavator 1 travels straight backward.

As shown in FIG. 14(G), when the foot pedal 75 is operated to the backward traveling R position and the wheel for turn 77 is turned downward, the control command for pilot pressure output is output to the second and fourth electromagnetic proportional valves 49 and 51. In this case, an output pressure from the fourth electromagnetic proportional valve 51 is controlled to be smaller than an output pressure of the second electromagnetic proportional valve 49 as the wheel for turn 77 is turned further downward. Consequently, the left traveling apparatus 2L is driven backward, the right traveling apparatus 2R is driven backward at speed lower than the speed of the left traveling apparatus 2L, and the hydraulic excavator 1 turns to the right while traveling backward. Note that when the wheel for turn 77 is turned to the bottom end, the control command for the pilot pressure output to the fourth electromagnetic proportional valve 50 is stopped. Consequently, the hydraulic excavator 1 travels backward and pivot-turns to the right.

As shown in FIG. 14(H), when the foot pedal 75 is operated to the backward traveling R position, the wheel for turn 77 is turned downward, and the switch for spin turn 78 is pushed, the control command is output to the second and third electromagnetic proportional valves 49 and 50 to output pilot pressure. Consequently, the left traveling apparatus 2L is driven backward, the right traveling apparatus 2R is driven forward, and the hydraulic excavator 1 spin-turns to the right.

As shown in FIG. 14(I), when the foot pedal 75 is operated to the backward traveling R position and the wheel for turn 77 is turned upward, the control command for pilot pressure output is output to the second and fourth electromagnetic proportional valves 49 and 51. In this case, the output pressure from the second electromagnetic proportional valve 49 is controlled to be smaller than the output pressure of the fourth electromagnetic proportional valve 51 as the wheel for turn 77 is turned further downward. Consequently, the right traveling apparatus 2R is driven backward, the left traveling apparatus 2L is driven backward at a speed lower than the speed of the right traveling apparatus 2R, and the hydraulic excavator 1 turns to the left while traveling backward. Note that, when the wheel for turn 77 is turned to the top end, the control command for the pilot pressure output to the second electromagnetic proportional valve 49 is stopped. Consequently, the hydraulic excavator 1 travels backward and pivot-turns to the left.

As shown in FIG. 14(J), when the foot pedal 75 is operated to the backward traveling R position, the wheel for turn 77 is turned upward, and the switch for spin turn 78 is pushed, the control command is output to the first and fourth electromagnetic proportional valves 48 and 51 to output pilot pressure. Consequently, the left traveling apparatus 2L is driven forward, the right traveling apparatus 2R is driven backward, and the hydraulic excavator 1 spin-turns to the left.

Further, the control apparatus 23 also performs control of the traveling speed on the basis of an input signal from the potentiometer 87 that detects an operation direction and an operation amount of the foot pedal 75. That is, in the case of a neutral position where the foot pedal 75 is not operated, the hydraulic pilot operation control is performed as explained above. Therefore, the control apparatus 23 does not output the control command for pilot pressure to the first to fourth electromagnetic proportional valves 48 to 51. However, when the foot pedal 75 is operated to the forward traveling F position or the backward traveling R position and the electric operation control is executed, the control apparatus 23 outputs the control command such that the output pressure from the first to fourth electromagnetic proportional valves 48 to 51 is larger as the operation amount of the foot pedal 75 operation is larger. Consequently, in the third embodiment, the traveling speed is controlled to be higher as the operation amount of the foot pedal 75 is larger.

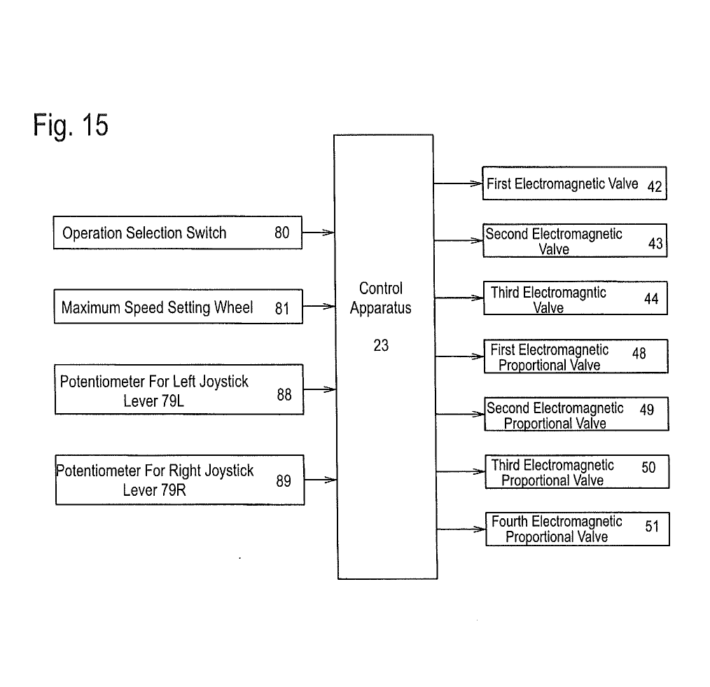

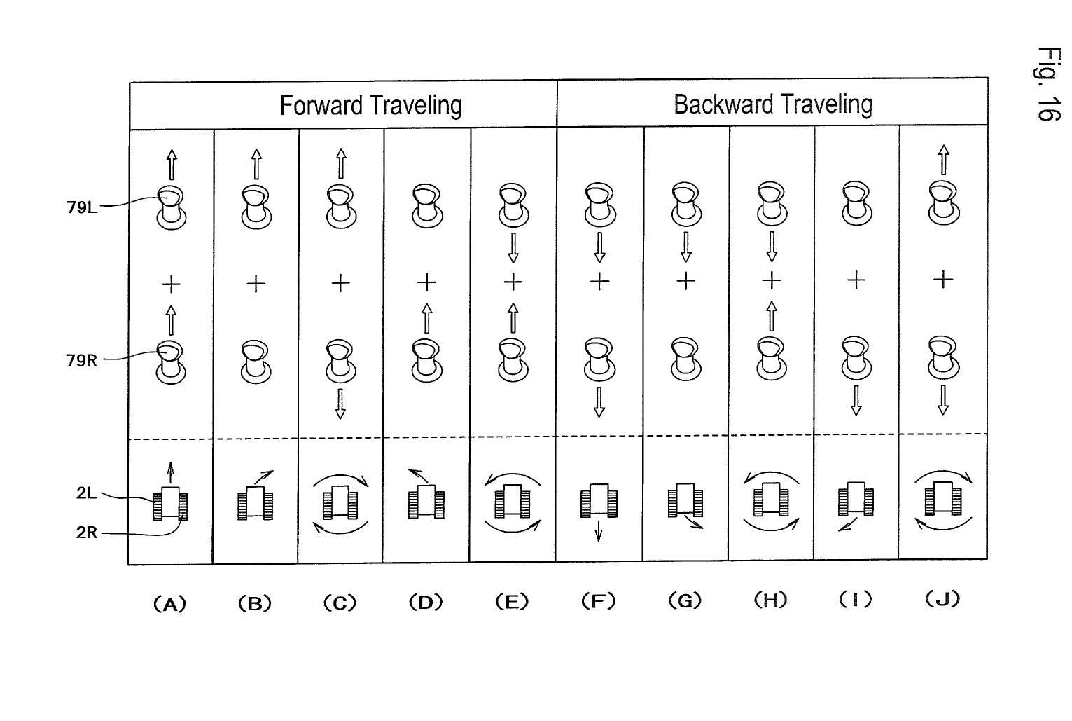

A fourth embodiment shown in FIGS. 15 and 16 is explained. In the fourth embodiment, left and right joystick levers 79L and 79R, an operation selection switch 80 provided on the rear surface of a gripping section of the left joystick lever 79L, and a maximum speed setting wheel 81 provided on the upper surface of a gripping section of the right joystick lever 79R are used as the electric operation device for traveling that outputs the electric signal for traveling. As shown in the block diagram of FIG. 15, the control apparatus 23 receives signals from the operation selection switch 80, the maximum speed setting wheel 81, and potentiometers 88 and 89 that respectively detect operation directions and operation amounts of the left and right joystick levers 79L and 79R. The control apparatus 23 outputs the control command to the first to third electromagnetic valves 42 to 44 and the first to fourth electromagnetic proportional valves 48 to 51 on the basis of the input signals and performs the hydraulic pilot operation control and the electric operation control (the hydraulic pilot operation prohibition control and the traveling control) explained above. In the fourth embodiment, as in the first embodiment, operation selection switch 80 is the operation selecting means for selecting the hydraulic pressure pilot operation and the electric operation. That is, the operation selection switch 80 in the fourth embodiment is the same as the operation selection switch 26 in the first embodiment. The control apparatus 23 performs the hydraulic pilot operation control when the operation selection switch 80 is not operated (OFF). On the other hand, when the operation selection switch 80 is operated (ON), the control apparatus 23 performs the electric operation control.

In the fourth embodiment, as in the first to third embodiments, during the execution of the electric operation control, the control apparatus 23 performs, on the basis of an input signal from the electric operation device for traveling, traveling control for outputting a control command for a pilot pressure output to the first to fourth electromagnetic proportional valves 48 to 51. A relation among the operation of the electric operation device for traveling in the traveling control, the control command to the first to fourth electromagnetic proportional valves 48 to 51, and a traveling direction of the hydraulic excavator 1 is explained with reference to FIG. 16.

First, the relation in the case of forward traveling of the hydraulic excavator 1 is explained with reference to FIGS. 16(A) to 16(E). As shown in FIG. 16(A), when both the left and right joystick levers 79L and 79R are operated to the front, the control command is output to the first and third electromagnetic proportional valves 48 and 50 to output pilot pressure. Consequently, the left and right traveling apparatuses 2L and 2R are driven forward and the hydraulic excavator 1 travels forward. In this case, if operation amounts of the left and right joystick levers 79L and 79R are the same, output pressures of the first and third electromagnetic proportional valves 48 and 50 are controlled to be the same pressure. Consequently, the left and right traveling apparatuses 2L and 2R are driven at the same speed and the hydraulic excavator 1 travels straight forward. If an operation amount of the right joystick lever 79R is smaller than an operation amount of the left joystick lever 79L, an output pressure from the third electromagnetic proportional valve 50 is controlled to be smaller than an output pressure of the first electromagnetic proportional valve 48. Consequently, the right traveling apparatus 2R is driven at speed lower than the speed of the left traveling apparatus 2L and the hydraulic excavator 1 turns to the right while traveling forward. On the other hand, if the operation amount of the left joystick lever 79L is smaller than the operation amount of the right joystick lever 79R, the output pressure from the first electromagnetic proportional valve 48 is controlled to be smaller than the output pressure of the third electromagnetic proportional valve 50. Consequently, the left traveling apparatus 2L is driven at speed lower than the speed of the right traveling apparatus 2R and the hydraulic excavator 1 turns to the left while traveling forward.

As shown in FIG. 16(B), when only the left joystick lever 79L is operated to the front, the control command for pilot pressure output is output to the first electromagnetic proportional valve 48. Consequently, the left traveling apparatus 2L is driven forward and the hydraulic excavator 1 travels forward and pivot-turns to the right.

As shown in FIG. 16(C), when the left joystick lever 79L is operated to the front and the right joystick lever 79R is operated to the back, the control command is output to the first and fourth electromagnetic proportional valves 48 and 51 to output pilot pressure. Consequently, the left traveling apparatus 2L is driven forward, the right traveling apparatus 2R is driven backward, and the hydraulic excavator 1 spin-turns to the right.

As shown in FIG. 16(D), when only the right joystick lever 79R is operated to the front, the control command for the pilot pressure output is output to the third electromagnetic proportional valve 50. Consequently, the right traveling apparatus 2R is driven forward and the hydraulic excavator 1 travels forward and pivot-turns to the left.

As shown in FIG. 16(E), when the left joystick lever 79L is operated to the back and the right joystick lever 79R is operated to the front, the control command is output to the second and third electromagnetic proportional valves 49 and 50 to output pilot pressure. Consequently, the left traveling apparatus 2L is driven backward, the right traveling apparatus 2R is driven forward, and the hydraulic excavator 1 spin-turns to the left.

The relation in the case of backward traveling of the hydraulic excavator 1 is explained with reference to FIGS. 16(F) to 16(J). As shown in FIG. 16(F), when both the left and right joystick levers 79L and 79R are operated to the back, the control command is output to the second and fourth electromagnetic proportional valves 49 and 51 to output pilot pressure.

Consequently, the left and right traveling apparatuses 2L and 2R are driven backward and the hydraulic excavator 1 travels backward. In this case, if operation amounts of the left and right joystick levers 79L and 79R are the same, output pressures of the second and fourth electromagnetic proportional valves 49 and 51 are controlled to be the same pressure. Consequently, the left and right traveling apparatuses 2L and 2R are driven at the same speed and the hydraulic excavator 1 travels straight backward. If an operation amount of the right joystick lever 79R is smaller than an operation amount of the left joystick lever 79L, an output pressure from the fourth electromagnetic proportional valve 51 is controlled to be smaller than an output pressure of the second electromagnetic proportional valve 49. Consequently, the right traveling apparatus 2R is driven at speed lower than the speed of the left traveling apparatus 2L and the hydraulic excavator 1 turns to the right while traveling backward. On the other hand, if the operation amount of the left joystick lever 79L is smaller than the operation amount of the right joystick lever 79R, the output pressure from the second electromagnetic proportional valve 49 is controlled to be smaller than the output pressure of the fourth electromagnetic proportional valve 51. Consequently, the left traveling apparatus 2L is driven at speed lower than the speed of the right traveling apparatus 2R and the hydraulic excavator 1 turns to the left while traveling backward.

As shown in FIG. 16(G), when only the left joystick lever 79L is operated to the back, the control command for the pilot pressure output is output to the second electromagnetic proportional valve 49. Consequently, the left traveling apparatus 2L is driven to the backward traveling side and the hydraulic excavator 1 travels backward and pivot-turns to the right.

As shown in FIG. 16(H), when the left joystick lever 79L is operated to the back and the right joystick lever 79R is operated to the front, the control command is output to the second and third electromagnetic proportional valves 49 and 50 to output pilot pressure. Consequently, the left traveling apparatus 2L is driven backward, the right traveling apparatus 2R is driven forward, and the hydraulic excavator 1 spin-turns to the right.

As shown in FIG. 16(I), when only the right joystick lever 79R is pulled back, a control command for pilot pressure output is output to the fourth electromagnetic proportional valve 51. Consequently, the right traveling apparatus 2R is driven backward and the hydraulic excavator 1 travels backward and pivot-turns to the left.

As shown in FIG. 16(J), when the left joystick lever 79L is operated to the front and the right joystick lever 79R is operated to the back, a control command is output to the first and fourth electromagnetic proportional valves 48 and 51 to output pilot pressure. Consequently, the left traveling apparatus 2L is driven forward, the right traveling apparatus 2R is driven backward, and the hydraulic excavator 1 spin-turns to the left.

Note that, as explained above, the left and right joystick levers 79L and 79R function as the electric operation device for traveling only during the execution of the electric operation control, that is, while the operation selection switch 80 is pushed.

Further, control apparatus 23 also performs control of traveling speed on the basis of input signals from potentiometers 88 and 89 that detect operation directions and operation amounts of the left and right joystick levers 79L and 79R and the maximum speed setting wheel 81. Speed control in the fourth embodiment is same as the speed control in the first embodiment. Therefore, detailed explanation of the speed control is omitted. The traveling speed is controlled such that the traveling speed is higher as the operation amounts of the left and right joystick levers 79L and 79R are larger and maximum traveling speed varies according to a setting value of the maximum speed setting wheel 81.

In the hydraulic excavator 1 in the second to fourth embodiments, action and effects same as the action and the effects in the first embodiment are attained. However, in the hydraulic excavator 1 in the second and third embodiments, the electric signal for traveling output from the electric operation device for raveling (the forward and backward traveling changeover switch 72 and the foot pedal 75) is used as the selection signal to use the electric operation device for traveling as the operation selecting means as well. Consequently, there is an advantage that it is unnecessary to separately provide the operation selecting means and it is also unnecessary to separately operate the operation selecting means.

### INDUSTRIAL APPLICABILITY

The present invention can be used in a hydraulic working machine such as a hydraulic excavator configured to be capable of changing between a standard specification and a remote operation adapted specification in which the hydraulic working machine can be controlled by remote operation.

1. A working vehicle comprising:
a hydraulic motor that drives a traveling apparatus;
a control valve for traveling of a hydraulic pilot type that performs oil supply and discharge control for the hydraulic motor;
a hydraulic pilot operation tool that actuates a pilot valve that outputs a pilot pressure to the control valve;
an electric operation device that outputs an electric signal; operation selecting means for selecting hydraulic pilot operation or electric operation;
a control apparatus that receives the electric signal from the electric operation device, and a selection signal from the operation selecting means, and outputs a control signal;
an electromagnetic valve for prohibiting pilot pressure from the pilot valve from reaching the control valve for traveling on the basis of the control signal;
an electromagnetic proportional valve that outputs pilot pressure to the control valve for traveling on the basis of the control signal from the control apparatus; and
a shuttle valve that directs one of the pilot pressure output from the pilot valve or the electromagnetic proportional valve to the control valve for traveling.

2. The working vehicle according to claim 1, further comprising:
a hydraulic actuator for work;
a control valve for work of a hydraulic pilot type that performs oil supply and discharge control for the hydraulic actuator for work;
a pilot valve for work that outputs pilot pressure to the control valve for work; and
a joystick-type operation lever, wherein
the joystick-type operation lever has a function of a hydraulic pilot operation tool for work that actuates the pilot valve for work on the basis of lever operation, and a function of electric operation device for traveling that outputs the electric signal for traveling to the control apparatus on the basis of lever operation, and,
the working vehicle is provided with an electromagnetic valve for prohibiting pilot operation for work that prohibits an output of the pilot pressure from the pilot valve for work to the control valve for work on the basis of the control signal from the control apparatus.

3. The working vehicle according to claim 1, wherein the operation selecting means is provided in the electric operation device for traveling.

4. The working vehicle according to claim 1, wherein the electric operation device for traveling is also used as the operation selecting means by using, as the selection signal, the electric signal for traveling output from the electric operation device for traveling.

5. The working vehicle according to claim 2, wherein the operation selecting means is provided in the electric operation device for traveling.

6. The working vehicle according to claim 2, wherein the electric operation device for traveling is also used as the operation selecting means by using, as the selection signal, the electric signal for traveling output from the electric operation device for traveling.
